(19) United States
(12) Patent Application Publication
(10) Pub. No.: US 2004/0011657 A1
(43) Pub. Date: Jan. 22, 2004

(54) Process for forming multi layered coated film and multi layered coated film

(76) Inventors: Hisaichi Muramoto, Kobe-shi (JP); Hitoshi Hori, Ibaraki-shi (JP); Koji Izumiya, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/378,924

(22) Filed: Mar. 5, 2003

(30) Foreign Application Priority Data
Mar. 5, 2002 (JP) 2002-059011

(51) Int. Cl. B32B 15/08

(52) U.S. Cl. 205/198; 428/458

(57) ABSTRACT

The present invention provides an improved 2 wet coating system. The present invention relates to a process for forming a multi layered coated film comprising the steps of: forming an uncured electrodeposition coated film on an electrically conductive substrate, applying an intermediate coating on the electrodeposition coated film, and then simultaneously heating and curing the uncured electrodeposition coated film and an uncured intermediate coated film, forming an uncured base coated film on the intermediate coated film, applying a clear top coating on the base coated film, and then simultaneously heating and curing the uncured base coated film and an uncured clear coated film; wherein the electrodeposition coating forms a self-stratifying coated film, and a dynamic glass transition temperature of a resin layer (α) in direct contact with the electrically conductive substrate and that of a resin layer (β) in direct contact with the intermediate coated film are controlled.

### FIELD OF THE INVENTION

The present invention relates to a process for forming a multi layered coated film, more specifically, a process for forming a multi layered coated film comprising the steps of: after applying an aqueous intermediate coating on a substrate, on which an uncured electrodeposition coated film is formed, by wet on wet coating; simultaneously heating and curing the both coated films (two wet coating system); after applying an aqueous base top coating and a clear top coating on the cured coated film by wet on wet coating; and simultaneously heating and curing the both coated film (second baking). In detail, it relates a method for forming a multi layered coated film, which has excellent chipping resistance, excellent appearance and yellowing resistance, and a multi-layered coated film obtained thereby.

### BACKGROUND OF THE INVENTION

In recent years, it has been strongly desired in the coating art, particularly the automobile coating art that coating process should be simplified and reduced so as to solve the problems of resource saving, cost saving, environmental load (such as VOC and HAPs) reducing, and the like. In a conventional coating and finish process of automobile, each of an electrodeposition coating, an intermediate coating and top coating used to form a layered coated film has been separately applied and cured by so-called 3 coat 3 bake coating process. However, in recent years, a process for forming a multi layered coated film comprising the steps of: after applying an aqueous intermediate coating on an uncured electrodeposition coated film formed by electrodeposition coating; simultaneously baking the both to a cured coated film (two wet coating system); after applying an aqueous base top coating and a clear top coating on the cured coated film by wet on wet coating; and simultaneously baking the both (second baking); has been used as described in FIG. 1. The process as used herein refers to a two wet coating system. It is required to reduce number of baking steps and maintain excellent coating performance by using the coating system as good as a 3 coat film obtained by a conventional 3 coat 3 bake coating process.

In Japanese Patent Kokoku Publication Nos. 20073/1981, 33992/1981 and 43155/1983, a general 2 wet coating system comprising an aqueous intermediate coating is disclosed. Therefore, it was shown that the coating system was well known 20 years ago.

However, there are some problems to be solved of performance of coating for automobile in a multi layered coated film obtained by the 2 wet coating system with the state of the art.

In the conventional 3 coat 3 bake coating process, it was possible for to maintain excellent impact resistance, particularly chipping resistance when subjecting the impact of a block such as a stone against automobile body on moving by introducing a specific intermediate coated film having excellent chipping resistance and the like. On the other hand, when the conventional intermediate coating is used in the 2 wet coating system, a deterioration of compatibility or reversement occurs at the interface between coated film layers obtained by wet on wet coating. Therefore, there was a problem that the multi layered coated film obtained by the 2 wet coating system was inferior in impact resistance, chipping resistance and appearance as compared with the coated film obtained by the conventional coating process.

In order to solve the problem, Japanese Patent Kokai Publication Nos. 10189/1994, 10190/1994, 17294/1994, 41787/1994, 41788/1994 and 65791/1994 suggest to introduce a resin layer having an ability of absorbing an impact for the coated film (so-called chipping resistance primer layer) particularly between the electrodeposition coated film and intermediate coated film during forming a multi layered coated film in the 2 wet coating system. However, if introducing the above step into the coating step of the automobile body, number of coating step increases, and it is not suitable for market needs of reducing number of steps and cost saving.

In the 2 wet coating process, there is a defect that surface roughness of the electrodeposition coated film has great effect on the whole appearance of the 3 coat film, that is, film defect such as surface roughness, crater or cissing of the surface of the electrodeposition coated film as an underlayer has great effect on the appearance. Therefore, it is strongly required for the electrodeposition coated film as an underlayer to have high surface smoothness and no defect as compared with the conventional coating system.

On the other hand, recently, in the coating art, particularly the automobile coating art, an aqueous coating has been remarkable in order to reduce environmental load (such as VOC). The aqueous coating is formed by water-solubilizing, water-dispersing or emulsifying a coated film formable resin having hydrophilic group, and is prepared by adding a neutralizing agent, such as amines, and an aqueous medium thereto and dispersing them therein. Japanese Patent No. 2989643 suggests an aqueous coating formed by directly neutralizing polyester resin with a basic substance such as an amine to self-emulsify, as a coated film formable resin that comprises an aqueous intermediate resin in the 2 wet coating system. However, since the polyester resin is easily hydrolyzed by directly contacting the basic substance such as the amine, it is problem to greatly degrade the storage stability of the aqueous intermediate resin. In addition, it is problem that the change of properties of the resin easily causes yellowing of the resulting multi layered coated film.

In automobile coating art, high elegance accomplished by the combination of a top coated film having high optical transmission and a multi-colored intermediate coated film underlying thereof as a whole appearance of a multi layered coated film is required mainly for a type of luxury car. Therefore, in the 2 wet coating system, it is required to form a colored intermediate coated film layer, which is not discolored and has the surface having high smoothness.

### OBJECTS OF THE INVENTION

A main object of the present invention is to provide a process for forming a multi layered coated film having excellent impact resistance, particularly chipping resistance as good as a 3 coat film obtained by a conventional 3 coat 3 bake coating process; excellent yellowing resistance of the coated film while maintaining excellent storage stability of an aqueous coating; and an appearance having high elegance depending to needs; in a 2 wet coating system for reducing number of coating steps, cost and environmental load.

### BRIEF EXPLANATION OF DRAWINGS

The present invention will become more fully understood from the detailed description given hereinbelow and the accompanying drawings which are given by way of illustration only, and thus are not limitative of the present invention, and wherein:

FIG. 1 is a flow chart illustrating one embodiment of process of the 2 wet coating system.

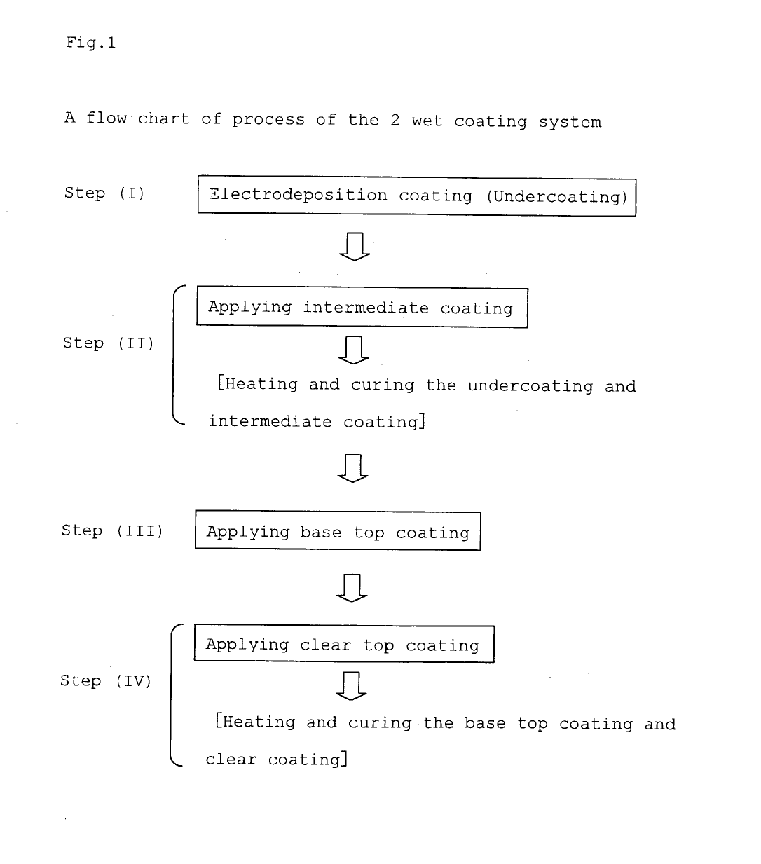

### SUMMARY OF THE INVENTION

The present invention relates to a process for forming a multi layered coated film comprising the steps of:

(I) conducting electrodeposition coating on an electrically conductive substrate to form an uncured electrodeposition coated film,

(II) applying an intermediate coating on the electrodeposition coated film to form an intermediate coated film, and then simultaneously heating and curing the uncured electrodeposition coated film and the uncured intermediate coated film,

(III) applying a base top coating on the intermediate coated film to form an uncured base coated film

(IV) applying a clear top coating on the base coated film to form a clear coated film, and then simultaneously heating and curing the uncured base coated film and the uncured clear coated film; wherein the electrodeposition coating forms a self-stratifying coated film at cured condition after finishing the step (II), and

a resin layer (α) in direct contact with the electrically conductive substrate has a dynamic glass transition temperature Tg(a) of 100 to 150° C. and a resin layer (β) in direct contact with the intermediate coated film has a dynamic glass transition temperature Tg(b) of 40 to 90° C. in the electrodeposition coated film formed from the electrodeposition coating.

As one embodiment, the present invention relates a process for forming a multi layered coated film comprising the steps of:

(I) conducting electrodeposition coating on an electrically conductive substrate to form an uncured electrodeposition coated film,

(I′) preheating the electrodeposition coated film at the temperature lower than a baking temperature necessary for curing the electrodeposition coated film to form an uncured self-stratifying electrodeposition coated film,

(II) applying an intermediate coating on the electrodeposition coated film to form an intermediate coated film, and then simultaneously heating and curing the uncured electrodeposition coated film and the uncured intermediate coated film,

(III) applying a base top coating on the intermediate coated film to form an uncured base coated film, and

(IV) applying a clear top coating on the base coated film to form a clear coated film, and then simultaneously heating and curing the uncured base coated film and the uncured clear coated film. In the process for forming the multi layered coated film, an aqueous coating can be used for the intermediate coating and base top coating.

The present invention also relates to a multi layered coated film formed by the above process.

### DETAILED DESCRIPTION OF THE INVENTION

The process for forming a multi layered coated film of the present invention will be explained in detail.

Step (I)

In step (I) of the process of the present invention, an uncured electrodeposition coated film are obtained by conducting electrodeposition coating on an electrically conductive substrate, optionally followed by conducting a post-treatment well known in the art (water washing, and air drying at room temperature).

Electrodeposition Coating and Process Thereof

The electrodeposition coating comprises a resin (a) having a solubility parameter δa, a resin (b1) having a solubility parameter δb1, a resin (b2) having a solubility parameter δb2, a curing agent (c) and a pigment, as essential components. The solubility parameters of the resin components satisfy a relationship represented by the following formulae:

[δa−(δb1+δb2)/2]≧1

(δb1−b2)≦±0.2

When the solubility parameters satisfy the relationship, the electrodeposition coating tends to form a cured self-stratifying coated film after the step (II) is completed. In the electrodeposition coated film formed, a resin layer (α) in direct contact with the electrically conductive substrate is formed from mainly the resin (a) and has a dynamic glass transition temperature Tg(a) of 100 to 150° C.; and a resin layer (β) in direct contact with the intermediate coated film is formed from mainly the resin (b1) and the resin (b2) and has a dynamic glass transition temperature Tg(b) of 40 to 90° C.

The electrodeposition coating forms an electrodeposition coated film having a multi layered structure by using resin components incompatible with each other. In the electrodeposition coated film, a resin layer having corrosion resistance is formed at the side in direct contact with the electrically conductive substrate, and a resin layer having impact resistance (chipping resistance) is formed at the side in direct contact with air (or the intermediate coated film). Therefore, a balance between excellent corrosion resistance and excellent impact resistance can be accomplished in the electrodeposition coated film. Since the side in direct contact with air (or the intermediate coated film) is also comprised from a resin having weather resistance, the electrodeposition coated film also has excellent weather resistance. In addition, when the resin having weather resistance at the side in direct contact with air (or the intermediate coated film) has good heat flow property on curing under applied heat, the electrodeposition coated film and the intermediate coated film directly contact therewith have excellent appearance.

In the multi layered coated film of the present invention, a resin layer (α) in direct contact with the electrically conductive substrate in the electrodeposition coated film formed from the electrodeposition coating is formed from mainly the resin (a), and the resin (a) as a main resin component is a cation-modified epoxy resin. A resin layer (β) in direct contact with the intermediate coated film in the electrodeposition coated film formed from the electrodeposition coating is formed from mainly the resin (b1) and the resin (b2), and as a main resin component the resin (b1) is a cation-modified acrylic resin having an amine value of 50 to 150, and the resin (b2) is an anionic polyester resin having an acid value of less than 10. The cation-modified acrylic resin (b1) and the anionic polyester resin (b2) satisfy a relationship represented by the following formula (2):

(δb1−δb2)≦±0.2

and the resin layer (β), of which the inner part is uniform, is formed by compatibilizing the both resins with each other.

The cation-modified epoxy resin (a) together with the resin (b1) and the resin (b2) satisfy a relationship represented by the following formula (1):

[δa−(δb1+δb2)/2]≧1

and the both resin, which are incompatible with each other, form the resin layer (α).

The term “solubility parameter δ” as used herein is generally called by persons skilled in the art as SP (solubility parameter), which shows a standard indicating degree of hydrophilicity or hydrophobicity and can be an important standard to judge compatibility between resins. A value of SP can be determined by a method called as turbidimetric method, which is well known to the art (K. W. Suh, D. H. Clarke J. Polymer Sci., A-1, 5, 1671 (1967)).

In the electrodeposition, the difference [δa−(δb1+δb2)/2] between the solubility parameter δa of the resin (a); and the average value of the solubility parameters of the resin (b1) and the resin (b2); is not less than 1. Generally, when the difference in solubility parameter between resins is not more than 0.2, the both resins are approximately perfectly compatible with each other. On the other hand, when the difference in solubility parameter between resins is larger than 0.2, the both resins are incompatible with each other, and the coated film exhibits a self-stratifying structure. However, since it is required to form a distinctly self-stratifying coated film structure in the electrodeposition coating, it is required to have the difference in solubility parameter of not less than 1. When the difference is smaller than 1, the distinctly self-stratifying coated film structure is not obtained after electrodeposition coating and curing under applied heat, and a balance between excellent corrosion resistance and excellent impact resistance (particularly chipping resistance) is not sufficiently accomplished.

The difference (δb1−δb2) in solubility parameter between the resin (b1) and the resin (b2) is not more than 0.2, and the both resins, which are perfectly dissolved in each other, comprise an uniform resin layer (β).

In the resin (a) and resins (b1) and (b2), the resin (a), which has larger solubility parameter, has higher affinity for the surface of an electrically conductive substrate having high surface polarity, such as metal. Therefore, the electrodeposition coated film layer formed from mainly the resin (a) is formed at the side contact with the electrically conductive substrate comprised of metallic material and the like on curing under applied heat. On the other hand, the resin (b1) and the resin (b2) are migrated at the side contact with air (or the intermediate coated film) to form a resin layer. It is considered that the difference in solubility parameter of the both resins promotes to stratify the resin layer.

Therefore, it is required to together satisfy the relationships represented by the formulae (1) and (2) in order to obtain a self-stratifying electrodeposition coated film having excellent appearance. When at least one relationship is not satisfied, a distinctly self-stratifying coated film structure is not obtained, or excellent appearance of the surface of the electrodeposition coated film is not sufficiently obtained even if the structure is obtained.

In order to form the self-stratifying coated film, it is required for a weight ratio [a/(b1+b2)] of the resin (a) to resins (b1) and (b2) based on solid content to be within the range of 3/7 to 7/3, preferably 4/6 to 6/4.

When the weight ratio is out of the range of 3/7 to 7/3, a plural layered structure is not obtained in the coated film after electrodeposition coating and baking, and a sea-island structure (or micro-domain structure) is formed such that the resin having higher content forms a continuous phase and the resin having lower content forms a discontinuous phase.

The stratifying state of the resin layer is determined by observing the section of the electrodeposition coated film using a video microscope, or a scanning electron microscope (SEM). The resin component comprising each resin layer is identified using, for example, a Fourier-transformed infrared attenuated total reflection (FTIR-ATR) spectrophotometer.

The composition for the electrodeposition coating of the present invention will be explained in detail. The resins (a) and (b1) having an amine value are neutralized with inorganic acids such as hydrochloric acid, nitric acid, phosphoric acid; or organic acids such as formic acid, acetic acid, lactic acid, sulfaminic acid and acetylglycinic acid in an amount enough to neutralize amino groups in each resin to be emulsified and dispersed in water as a cationized emulsion. It is preferable to separately conduct the emulsification and dispersion of the resins (a) and (b1), but they may be conducted after mixing the both resins. Since the resin (b2) is an anionic polyester resin having an acid value of less than 10, it has no dispersibility in water, and it is incorporated into the coating as a core in an emulsion particle. It is desired for any resin emulsion to involve a curing agent (c) as a core in the step of emulsifying and dispersing.

The electrodeposition coating at least comprises, as a composition, particles A comprising the resin (a) as a shell, particles B comprising at least the resin (b1) as a shell and a pigment dispersion, and the resin (b2) is present in the particles A and/or particles B as a core together with the curing agent (c).

The electrodeposition coating at least comprises, as another composition, particles C comprising the resin (a) and resin (b1) as a shell and a pigment dispersion, and the resin (b2) is present in the particles C as a core together with the curing agent (c). In addition, the electrodeposition coating may comprise the particles A, B and C.

In the electrodeposition coated film formed by the electrodeposition coating, a resin layer (α) mainly formed from the resin (a) has a dynamic glass transition temperature Tg(a) of 100 to 150° C., preferably 110 to 140° C. When the dynamic glass transition temperature Tg(a) is higher than 150° C., the resin layer (α) is brittle, and the impact resistance is poor. On the other hand, when the dynamic glass transition temperature Tg(a) is lower than 100° C., the corrosion resistant is poor.

In the electrodeposition coated film formed by the electrodeposition coating, a resin layer (β) mainly formed from the resins (b1) and (b2) has a dynamic glass transition temperature Tg(b) of 40 to 90° C., preferably 60 to 80° C. When the dynamic glass transition temperature Tg(b) is higher than 90° C., the flexibility and impact resistance of the resin layer (β) are poor. On the other hand, when the dynamic glass transition temperature Tg(b) is lower than 40° C., the corrosion resistance is poor.

The dynamic glass transition temperature is determined by measuring a dynamic glass transition temperature using a sample of the electrodeposition coated film with a measuring apparatus of dynamic viscoelastic, such as Rheovibron, manufactured by Orientec Co., Ltd. and Rheometrics Dynamic Analyzer, manufactured by Rheometrics Co. The sample is prepared by conducting electrodeposition coating on a tinplate substrate; curing it to form a electrodeposition coated film; and separating the coated film using mercury.

The resin (a) is a cation-modified epoxy resin as described above. Generally, the cation-modified epoxy resin is prepared by opening all epoxy rings in a molecule of the epoxy resin as a starting material by the reaction with amines, such as primary amine, secondary amine and an acid salt of tertiary amine. A typical example of the starting material includes polyphenol polyglycidyl ether type epoxy resin, which is a reaction product of a polycyclic phenol compound, such as bisphenol A, bisphenol F, bisphenol S, phenol novolak, and cresol novolak, with epichlorohydrin. Another example of the starting material resin includes an epoxy resin having an oxazolidone ring described in Japanese Patent Kokai Publication No. 306327/1993. The epoxy resin is obtained by reacting a diisocyanate compound or a bis-urethane compound (obtained by blocking an NCO group of a diisocyanate compound with lower alcohol, such as methanol or ethanol) with epichlorohydrin.

The above starting material resin, before the ring-opening reaction of epoxy rings with amines, can be chain-extended by using difunctional polyester polyol, polyether polyol, bisphenol, dibasic carboxylic acid and the like. Similarly, before the ring-opening reaction of epoxy rings with amines, a monohydroxyl compound, such as 2-ethylhexanol, nonyl phenol, ethylene glycol mono-2-ethylhexylether, and propylene glycol mono-2-ethylhexylether can also be added to a part of epoxy rings, in order to control molecular weight or amine equivalent and to improve of heat flow property etc.

Examples of the amines, which can be used for ring-opening an epoxy group and introducing an amino group thereto, include primary amine, secondary amine, or an acid salt of tertiary amine, such as butylamine, octylamine, diethylamine, dibutylamine, methylbutylamine, monoethanolamine, diethanolamine, N-methylethanolamine, an acid salt of triethylamine and an acid salt of N, N-dimethylethanolamine. A secondary amine having ketimine blocked primary amino group, such as aminoethylethanolamine methylisobutylketimine can be also used. In order to ring-open all epoxy rings, it is required to react the amines with epoxy rings in at least equivalent weight.

It is desired for the cation-modified epoxy resin to have a number average molecular weight of 1,500 to 5,000, preferably 1,600 to 3,000. When the number average molecular weight is lower than 1,500, the physical properties of the resulting cured coated film, such as solvent resistance and corrosion resistance are poor. On the other hand, when the number average molecular weight is higher than 5,000, it is difficult to control the viscosity of the resin solution, and it is difficult to synthesize the resin as well as it is difficult to handle in operation, such as emulsification and dispersion of the resulting resin. In addition, since the resin solution has high viscosity, the flow property is poor on curing under applied heat, which degrades the appearance of the resulting coated film too much.

It is desired for the cation-modified epoxy resin to be molecular designed to have a hydroxyl number of 50 to 250. When the hydroxyl number is lower than 50, the curability of the resulting coated film is degraded. On the other hand, when the hydroxyl number is higher than 250, excess hydroxyl groups remain in the coated film after curing, which degrades its water resistance.

It is desired for the cation-modified epoxy resin to be molecular designed to have a amine value of 40 to 150. When the amine value is lower than 40, the emulsification and dispersion of the epoxy resin in an aqueous medium by neutralizing with the acid is not sufficiently conducted. On the other hand, when the amine value is higher than 150, excess amino groups remain in the coated film after curing, which degrades its water resistance. In addition, it is desired for the cation-modified epoxy resin to have a softening point of not less the 80° C., preferably not less than 100° C., in order to accomplish a balance at high level between the solvent resistance, weather resistance and corrosion resistance of the cured coated film, and appearance of the coated film, which is the object of the present invention.

The resin (b1) is a cation-modified acrylic resin as described above. The cation-modified acrylic resin can be synthesized by ring opening addition polymerization of acrylic copolymer containing plural oxirane rings and hydroxyl groups in a molecular and amines. The acrylic copolymer is obtained by copolymerization of glycidyl (meth)acrylate; hydroxyl group containing acrylic monomer (for example, addition product of hydroxyl group containing (meth)acrylic ester, such as 2-hydroxymethyl (meth)acrylate, 2-hydroxypropyl (meth)acrylate, 2-hydroxybutyl (meth)acrylate, or 2-hydroxyethyl (meth)acrylate; and ε-caprolactone); and the other acrylic monomer and/or non-acrylic monomer.

Examples of the other acrylic monomers include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, cyclohexyl (meth)acrylate, 2-ethylhexyl (meth)acrylate, lauryl (meth)acrylate and isobornyl (meth)acrylate. Examples of the non-acrylic monomers include styrene, vinyl toluene, a-methylstyrene, (meth)acrylonitrile, (meth)acrylamide and vinyl acetate.

An oxirane ring containing acrylic resin based on the glycidyl (meth)acrylate can be converted into a cation-modified acrylic resin by opening all oxirane rings in the epoxy resin by the reaction with primary amine, secondary amine or an acid salt of tertiary amine.

The cation-modified acrylic resin may be directly synthesized by a method of copolymerizing acrylic monomer having amino group and the other monomer. In the method, the glycidyl (meth)acrylate is replaced with amino group containing acrylic monomer, such as N,N-dimethylaminoethyl (meth)acrylate, N,N-dimethylaminopropyl (meth)acrylamide and N,N-di-t-butylaminoethyl (meth)acrylate, and the cation-modified acrylic resin can be obtained by copolymerizating the amino group containing acrylic monomer, the hydroxyl group containing acrylic monomer and the other acrylic monomer and/or non-acrylic monomer.

The resulting cation-modified acrylic resin may be optionally a self-crosslinking type acrylic resin obtained by incorporating a blocked isocyanate group thereto by an addition reaction with a half-blocked diisocyanate compound, as described in Japanese Patent Kokai Publication No 333528/1996.

It is desired for the resin (b1) to be molecular designed to have a hydroxyl number of 50 to 150. When the hydroxyl number is lower than 50, the curability of the resulting coated film is degraded. On the other hand, when the hydroxyl number is higher than 150, excess hydroxyl groups remain in the coated film after curing, which degrades its water resistance. In the resin (b1), the smoothness of the surface of the coated film can be improved by using a primary hydroxyl group together with a secondary hydroxyl group to control the velocity of curing reaction. In addition, the interlaminar bonding strength of the coated films is also improved by using with the secondary hydroxyl group. It is desired for the resin (b1) to have a number average molecular weight of 2,000 to 15,000, preferably 3,000 to 10,000. When the number average molecular weight is lower than 2,000, the physical properties of the resulting cured coated film, such as solvent resistance, are poor. On the other hand, when the number average molecular weight is higher than 15,000, the appearance of the resulting electrodeposition coated film is degraded too much. The resin (b1) may be comprised of one type, or of two or more types in order to accomplish a balance between coating properties.

It is desired for the cation-modified acrylic resin to be molecular designed to have a amine value of 50 to 150. When the amine value is lower than 50, the emulsification and dispersion of the acrylic resin in an aqueous medium by neutralizing with the acid is not sufficiently conducted. On the other hand, when the amine value is higher than 150, excess amino groups remain in the coated film after curing, which degrades its water resistance.

The resin (b2) is an anionic polyester resin as described above. The anionic polyester resin can be prepared by dehydration condensation reaction and/or addition reaction of polyols, such as, neopentyl glycol, trimethylolpropane, ethylene glycol, diethylene glycol, propylene glycol, 1,6-hexanediol, glycerin and pentaerythritol; polybasic acid, such as phthalic acid, isophthalic acid, trimellitic acid, terephthalic acid, pyromellitic acid, tetrahydrophthalic acid, hexahydrophthalic acid, succinic acid, adipic acid, and sebacic acid and anhydrides thereof; and optionally, lactones, such as δ-butyrolactone and ε-caprolactone; any types of saturated and/or unsaturated fatty acids as modified, such as coconut oil fatty acid, tung oil fatty acid, soybean oil fatty acid and linseed oil fatty acid, and mono-, di-, or tri-glycerides thereof, and Carjurer E-10 (monoepoxide having a branched alkyl group with 10 carbon atoms, available from Shell Chemical Co.) according to conventional methods.

The anionic polyester resin may contain a urethane bond in suitable quantity in part. An introduction of the urethane bond can be carried out by urethane bonding diisocyanates, such as 4,4′-diphenylmethane diisocyanate and isophorone diisocyanate, and partly extending chains. The above resin is used as a part of the above polyol components optionally, it is possible to impart curing reactivity to the polyester resin by bonding to the polyols after blocking one end of the diisocyanate using a block agent. In the same way as the resin (b1), the anionic polyester resin may be optionally a self-crosslinking type resin obtained by incorporating a blocked isocyanate group thereto by an addition reaction with a half-blocked diisocyanate compound, or by a partial co-condensation with a melamine resin. The self-crosslinked resin can be suitably used in the present invention, because of superiority in curing reactivity.

It is desired for the anionic polyester resin to be designed to have an acid value of less than 50, preferably from 1 to 8. Because the resin is encapsulated in an emulsion under hydrophobic atmosphere as a core in the resin particles A, B or C of the electrodeposition coating by increasing degree of hydrophobicity of the resin as possible. When the resin is encapsulated in the emulsion, the resin does not directly contact with an acid or base present in bulk water as a neutralizing agent, and it is possible to prevent the polyester resin from deteriorating by its hydrolysis. Therefore, the coating has long-term storage stability. If the resin has an acid value of not less than 10, it is easily neutralized with the base and the like present in bulk water, and molecular chain in the resin is migrated to not only the core of the emulsion particles but the shell of the particles. Therefore, it directly contacts with water, and the degree of hydrolysis of the ester bond in the resin molecular increases.

It is desired for the resin (b2) to be molecular designed to have hydroxyl number of 50 to 150. When the hydroxyl number is lower than 50, the curability of the resulting coated film is degraded. On the other hand, when the hydroxyl number is higher than 150, excess hydroxyl groups remain in the coated film after curing, which degrades its water resistance. It is desired for the resin (b2) to have a number average molecular weight of 500 to 3,000, preferably 1,000 to 2,000. When the number average molecular weight is lower than 500, the physical properties of the resulting cured coated film, such as solvent resistance, are poor. On the other hand, when the number average molecular weight is higher than 3,000, the viscosity of the resin solution is high, and it is difficult to handle in operation, such as emulsification and dispersion of the resulting resin. In addition, the heat flow property is poor on curing under applied heat, which degrades the appearance of the resulting coated film too much. The resin (b2) may be comprised of one type, or of two or more types in order to accomplish a balance between coating properties.

It is possible to improve the heat flow property of the resin layer (β) of the electrodeposition coated film by using the resin (b2) in the step (I′) of preheating at the temperature lower than the curing temperature, or the step (II) of baking at the curing temperature. Therefore, the smoothness of the surface of the coated film can be largely improved, even if it is after applying the intermediate coating on the electrodeposition coated film. In order to reduce the melt viscosity on heat flowing, it is important for the polyester resin (b2) to have relatively low molecular weight as compared with the acrylic resin (b1). It is preferable to improve the smoothness of the surface of the coated film and the interlaminar bonding strength of the coated films by addition modification using Carjurer E-10 (monoepoxide having a branched alkyl group with 10 carbon atoms, commercially available from Shell Chemical Co.) and the like to increase secondary hydroxyl groups.

In order to accomplish the technical effect, it is desired for a weight ratio (b1/b2) of the resin (b1) to the resin (b2) to be within the range of 5/5 to 9/1. When the weight ratio is larger than 9/1, the amount of the resin (b2) is small, and the heat flow property is not sufficiently obtained. Therefore, the smoothness of the surface of the coated film is not sufficiently obtained. In addition, the technical effect of improving the interlaminar bonding strength to the intermediate coated film is not also sufficiently obtained. On the other hand, when the amount of the resin (b2) is too large as compared with the resin (b1), the amount of the core component in the electrodeposition resin particles is too large, and it is difficult to prepare the coating by water dispersing.

The curing agent (c) may be of any types as long as it is possible to cure each resin component on heating, but preferred is a blocked isocyanate suitable as a curing agent for the electrodeposition coating.

Examples of the polyisocyanates used as a starting material of the blocked isocyanate include aliphatic diisocyanates, such as hexamethylene diisocyanate (comprising trimer), tetramethylene diisocyanate and trimethylhexamethylene diisocyanate; cycloaliphatic diisocyanates, such as isophorone diisocyanate and 4,4′-methylene bis(cyclohexylisocyanate); aromatic diisocyanates such as 4,4′-diphenylmethane diisocyanate, tolylene diisocyanate and xylylene diisocyanate; and the like. The blocked isocyanate can be obtained by blocking the polyisocyanates with a suitable block agent.

Examples of the block agents suitably used include monovalent alkyl (or aromatic) alcohols, such as n-butanol, n-hexyl alcohol, 2-ethylhexanol, lauryl alcohol, phenol carbinol and methyl phenyl carbinol; cellosolves, such as ethylene glycol monohexyl ether and ethylene glycol mono-2-ethylhexyl ether; polyether type both ends type diols, such as polyethylene glycol, polypropylene glycol, polytetramethylene ether glycol phenol; polyester type both ends type polyols formed from diols, such as ethylene glycol, propylene glycol and 1,4-butanediol and dicarboxylic acid, such as oxalic acid, succinic acid, adipic acid, suberic acid and sebacic acid; phenols, such as para-t-butyl phenol and cresol; oximes, such as dimethyl ketoxime, methylethyl ketoxime, methyl isobutyl ketoxime, methylamyl ketoxime and cyclohexanone oxime; and lactams represented by ε-caprolactam and ε-butyrolactam, lactams. Particularly, in view of curing property of resins when simultaneously baking with the intermediate coated film in the post step, the block agents of oximes and lactams are suitable used, because they dissociate at low temperature.

It is desired that the isocyanate previously are blocked by one or more types of the blocking agents. A blocking ratio can preferably be 100% in order to secure storage stability of a coating, unless it is modification reacted with the each resin component.

It is desired for a weight ratio of the blocked isocyanate to total weight of the resin components (a), (b1) and (b2), which varies depending to degree of crosslinking necessary to an application of the cured coated film, to be within the range of 15 to 40% by weight in view of physical properties of the coated film. When the weight ratio is smaller than 15% by weight, the curability of the coated film is degraded, and the physical properties of the coated film, such as mechanical strength, are degraded. On the other hand, when the weight ratio is larger than 40% by weight, the coated film is overcured, and the physical properties of the coated film, such as impact resistance, are degraded. The blocked isocyanate may be used in combination of two or more in order to adjust the physical properties, degree of curing and curing temperature of the coated film.

In order to allow the blocked isocyanate to be distribution dissolved in each layer of the electrodeposition coated film after stratifying and to accomplish a balance of the curability of the resin layer (α) comprising the resin (a) and the simultaneous curing of the resin layer (β) comprising the resins (b1) and (b2), it is important that the curing agent (c) is consisted of two or more sorts of blocked isocyanates and a solubility parameter (δd) of the blocked isocyanate having a weight larger than the half of the curing agent or the blocked isocyanate as a main component satisfies a relationship represented by the following formula:

δa<δd<(δb1+δb2)/2

The relationship is an important guiding principle for accomplishing the present invention so as to improve the interlaminar bonding strength of the plural layered electrodeposition coated film and the appearance of the multi layered coated film after applying the intermediate coating or the top coating.

It is desired for the particles A, B and C to have an average diameter of 0.01 to 0.5 μm, preferably 0.02 to 0.3 μm, more preferably 0.05 to 0.2 μm. When the average diameter is smaller than 0.01 μm, the amount of the neutralizing agent necessary to water dispersing the resin component is excess, and the efficiency of the electrodeposition coating based on a certain electrical quantity is degraded. On the other hand, when the average diameter is larger than 0.5 μm, the dispersibility of the particles is degraded, and the storage stability of the electrodeposition coating is degraded.

The pigment used in the method of the present invention is not limited as long as it has been conventionally used for a coating. Examples thereof include a coloring pigment, such as carbon black, titanium dioxide and graphite; an extender pigment, such as kaolin, aluminum silicate (clay) and talc; a rust preventive pigment, such as aluminum phosphomolybdate. The important pigments for dispersing in the plural layered cured coated film after electrodeposition coating are titanium dioxide, carbon black, aluminum silicate (clay) and aluminum phosphomolybdate. Particularly, titanium dioxide and carbon black are suitable for the electrodeposition coated film, because they have high opacifying properties and are cheap. The pigment may be used alone, but it is generally used in combination of two or more depending on its application.

It is desired for a weight ratio [P/(P+V)] of the pigment (P) to the total weight (P+V) of the pigment and resin solid content (V) to be within the range of 10 to 30% by weight. The weight ratio is represented by PWC.

When the weight ratio is smaller than 10% by weight, the amount of the pigment is too small, and the barrier properties of corrosion factor, such as moisture are largely degraded. Therefore, the weather resistance and corrosion resistance at the level of practical use are not sufficiently obtained. On the other hand, when the weight ratio is larger than 30% by weight, the amount of the pigment is too large, and the viscosity of the coating on curing increases. Therefore, the flow property is degraded, and the appearance of the coated film is largely degraded.

The resin solid content (V) as used herein refers to the total solid content of the all resin binder comprising the electrodeposition coated film including the resins (a), (b1) and (b2) as a main resin of the electrodeposition coating, the curing agent (c) and pigment dispersing resin.

The pigment for the electrodeposition coating is added to the coating after preparing a pigment paste by dispersing the pigment in a dispersing resin. The pigment dispersing resin having the same type and composition as the resin component (a) or having approximate composition to the resin (a) is suitable. The suitable amount of the dispersing resin based on the weight of the pigment is within the range of 5 to 40% by weight of solid content. When the amount of the dispersing resin is smaller than 5% by weight, it is difficult to secure the dispersion stability of the pigment. On the other hand, when the amount of the dispersing resin is larger than 40% by weight, it is difficult to control the curability of the coated film.

It is desired for the total solid content of the electrodeposition coating composition to be adjusted to the range of 15 to 25% by weight. In order to adjust the total solid content, it is preferable to use an aqueous medium, such as water or a mixture of water and hydrophilic organic solvent. The coating composition may contain a small amount of additive. Examples of the additives include ultraviolet absorbing agent, oxidation inhibiting agent, surface active agent, smoothing agent for the surface of the coated film, curing accelerator (such as organic tin compound) and the like.

In the method of forming the electrodeposition coated film of the present invention, the electrically conductive substrate to be coated is connected to a cathode electrode, and the electrodeposition coating is carried out at a bath temperature of 15 to 35° C. and an applied voltage of 10 to 400 V to form the electrodeposition coated film having a dry thickness of 10 to 30 μm. It is desired to sufficiently conduct a post-treatment well known in the art by water washing (including industrial water washing and deionized water washing) and drying (including air drying at room temperature or air blow drying) on the wet electrodeposition coated film after the electrodeposition coating in order to reduce film defects, such as foaming and blister.

Step (I′)

In the process for forming a multi layered coated film of the present invention, it is the step of optionally preheating the electrodeposition coated film at the temperature lower than a baking temperature necessary for curing the electrodeposition coated film to form an uncured self-stratifying electrodeposition coated film.

Step of Preheating

In the two wet coating system, the step of preheating an uncured electrodeposition coated film may be optionally conducted before the subsequent step of applying an intermediate coated film. Particularly, in Japanese Patent Kokoku Publication No. 43155/1983, a basic step of preheating in the two wet coating system is described in detail. The object of preheating the electrodeposition coated film is generally to improve the finishing of the cured coated film by removing a volatile material from an inner portion of the wet coated film and by improving the smoothness of the coated film before the step of baking. However, in the two wet coating system of the present invention, the step of preheating has a special object other than the above object.

It is important to promote or complete phase transition, that is, self-stratifying in the electrodeposition coated film to a certain degree by preheating the wet coated film at 60 to 120° C., which is lower than the baking temperature of the electrodeposition coated film, for 1 to 15 minutes, in order to easily form distinct multi layered structure after the step of applying the intermediate coating thereby improving the appearance and physical properties, such as impact resistance (chipping resistance), corrosion resistance and weather resistance of the coated film. For the reason, in the present invention, the technical effect of remarkably improving the appearance and physical properties of the objective multi layered coated film can be obtained optionally by introducing the step (I′).

Step (II)

In the process for forming a multi layered coated film of the present invention, it is the step of simultaneously heating and curing the uncured electrodeposition coated film and an uncured intermediate coated film, after applying an aqueous intermediate coating on the uncured electrodeposition coated film formed after the step (I) and optionally the subsequent step (I′).

Aqueous Intermediate Coating and Process for Applying it

The aqueous intermediate coating used in the step (II) is applied in order to opacify the substrate for the electrodeposition coated film, secure the surface smoothness after applying top coating and impart the physical properties of the coated film, such as impact resistance and chipping resistance.

In automobile coating art, high elegance accomplished by the combination of a top coated film having high optical transmission and a multi-colored intermediate coated film underlying thereof as a whole appearance of a multi layered coated film is required mainly for a type of luxury car. Therefore, in the 2 wet coating system, it is required to form a colored intermediate coated film layer, which is not discolored and has the surface having high smoothness.

The aqueous intermediate coating is applied on the substrate formed the uncured electrodeposition coated film thereon and is baked to simultaneously form the both coated films as a cured coated film.

The aqueous intermediate coating comprises a resin (d1) having a solubility parameter (δd1), a resin (d2) having a solubility parameter (δd2), a curing agent (e) and a pigment as a essential component. In the baked intermediate coated film, the solubility parameters (δd1) and (δd2) preferably satisfy a relationship represented by the following formulae:

[(δb1+δb2)/2−(δd1+δd2)/2]≧±0.3 (5)

(δd1+δd2)≦±0.2 (6)

and a dynamic glass transition temperature Tg(d) of the intermediate coated film preferably satisfies a relationship represented by the following formula:

[Tg(b)−Tg(d)]≦±20° C. (7)

The relationship represented by the formula (5) is important to secure the interface of the intermediate coated film layer and electrodeposition coated film layer (β) and to unite the physical properties of the coated films.

When the difference [(δb1+δb2)/2−(δd1+δd2)/2] between an average value [(δb1+δb2)/2] of the solubility parameters of the resins (b1) and (b2) comprising the resin layer (β) in the electrodeposition coated film and an average value [(δd1+δd2)/2] of the solubility parameters of the resins (d1) and (d2) comprising the intermediate coated film layer is smaller than ±0.3, the both coated films formed by wet on wet coating are completely compatibilized particularly in the step of baking. Therefore, the interface of the intermediate coated film layer and electrodeposition coated film layer is not present, and it is not suitable for obtaining the multi layered coated film of the present invention.

The relationship represented by the formula (6) is important to secure the compatibility of the resins (d1) and (d2) comprising the intermediate coated film layer to homogenize the composition of the coated film. Therefore, the surface smoothness of the intermediate coated film is improved. When the difference (δd1−δd2) between the solubility parameters of the both resins is larger than 0.2, the surface smoothness of the intermediate coated film is degraded.

It is required to satisfy the both relationships represented by the formulae (5) and (6) in order to prevent the electrodeposition coated film and intermediate coated film from compatibilizing and obtain the intermediate coated film having excellent appearance. When at least one relationship represented by the either formula is not satisfied, the both coated films are completely compatibilized, or the surface appearance of the intermediate coated film is not sufficiently obtained even if the interface of the intermediate coated film layer and electrodeposition coated film layer can be secured.

The relationship represented by the formula (7) is important to sufficiently obtain the impact resistance and chipping resistance by the intermediate layer together with the electrodeposition coated film layer (β). It is required for the difference [Tg(b)−Tg(d)] between a dynamic glass transition temperature Tg(d) of the intermediate coated film and a dynamic glass transition temperature Tg(b) of the resin layer (β) in the electrodeposition coated film to design to be not larger than 20° C. When the difference is larger than 20° C., the physical properties of the coated film are not sufficiently obtained.

The aqueous intermediate coating is prepared by dispersing solid content thereof comprising thermoplastic resin (binder), curing agent, pigment dispersion paste and the like in water comprising a hydrophilic medium, such as alcohol.

In the present invention, the thermoplastic resin as a binder is mainly comprised of the resin (d1), which is an anion-modified acrylic resin having an acid value of 10 to 100, and the resin (d2), which is polyester resin having an acid value of less than 10. The intermediate coating is an aqueous coating comprising a core/shell type aqueous dispersion prepared from the polyester resin as a core and the acrylic resin as a shell.

The resin (d1) is an anion-modified acrylic resin as described above. The anion-modified acrylic resin can be synthesized by solution polymerization or bulk polymerization of an acrylic monomer and/or non-acrylic monomer containing comprising a monomer having an acidic group as well known in the art.

Examples of monomers having an acidic group include (meth)acrylic acid, itaconic acid, maleic acid, fumaric acid, crotonic acid and the like. Examples of monomers having a phosphoric group include mono(meth)acryloyl acid phosphate (“JAMP-514” commercially available from Johoku Chemical Co. Ltd.), mono(2-(meth)acryloyl oxyethyl)acid phosphate (“Lightester PM” and “Lightester PM” commercially available from Kyoei Chemical Co., Ltd.) amd the like.

The objective acrylic copolymer is obtained by copolymerization of at least one of the monomers having the acidic group, the hydroxyl group containing acrylic monomer and the other acrylic monomer and/or non-acrylic monomer. The hydroxyl group containing acrylic monomer and the acrylic monomer and/or non-acrylic monomer are the same as described in the resin (b1).

It is desired for the resin (d1) to be molecular designed to have hydroxyl number of 50 to 150. When the hydroxyl number is lower than 50, the curability of the resulting coated film is degraded. On the other hand, when the hydroxyl number is higher than 150, excess hydroxyl groups remain in the coated film after curing, which degrades its water resistance. With regard to the hydroxyl groups in the resin (d1), the smoothness of the surface of the coated film can be improved by using a primary hydroxyl group together with a secondary hydroxyl group to control the velocity of curing reaction. In addition, the interlaminar bonding strength of the coated films is also improved by using with the secondary hydroxyl group. It is desired for the resin (d1) to have a number average molecular weight of 5,000 to 100,000, preferably 10,000 to 50,000. When the number average molecular weight is lower than 5,000, the viscosity of the resin solution is too low, and it is mixed with the uncured electrodeposition coated film underlying thereof, or the inversion of the layer occurs. In addition, the physical properties of the resulting cured coated film, such as solvent resistance, are poor.

On the other hand, when the number average molecular weight is higher than 100,000, the viscosity of the resin solution is high, and it is difficult to handle in operation, such as emulsification and dispersion of the resulting resin. In addition, the heat flow property is poor on curing under applied heat, which degrades the appearance of the resulting coated film too much. The resin (d1) may be comprised of one type, or of two or more types in order to accomplish a balance between coating properties.

It is desired for the anion-modified acrylic resin to be molecular designed to have an acid value of 10 to 100, preferably 30 to 80. When the acid value is smaller than 10, emulsification and dispersion of the resin in water medium is not sufficiently obtained by the neutralization with an acid group. On the other hand, when the acid value is larger than 100, excess acid groups remain in the coated film after curing, which degrades its water resistance.

The resin (d2) is an anionic polyester resin as described above. The anionic polyester can be synthesized and used as described in the polyester resin comprising the electrodeposition coating. It is desired for the anionic polyester resin to be designed to have a acid value of less than 10, preferably 1 to 8. It is reason that the resin is encapsulated as a core of the core/shell type resin particle under hydrophobic atmosphere in the dispersion. When the resin is encapsulated in the dispersion, the resin does not directly contact with an acid or base present in bulk water as a neutralizing agent, and it is possible to prevent the polyester resin from deteriorating by its hydrolysis. Therefore, the coating has long-term storage stability. If the resin has an acid value of not less than 10, it is easily neutralized with the base and the like present in bulk water, and molecular chain in the resin is migrated to not only the core of the dispersion particles but the shell of the particles. Therefore, it directly contacts with water, and the degree of hydrolysis of the ester bond in the resin molecular increases.

It is desired for the resin (d2) to be molecular designed to have hydroxyl number of 50 to 220. When the hydroxyl number is lower than 50, the curability of the resulting coated film is degraded. On the other hand, when the hydroxyl number is higher than 220, excess hydroxyl groups remain in the coated film after curing, which degrades its water resistance. It is desired for the resin (d2) to have a number average molecular weight of 500 to 10,000, preferably 800 to 5,000. When the number average molecular weight is lower than 500, the physical properties of the resulting cured coated film, such as solvent resistance, are poor. On the other hand, when the number average molecular weight is higher than 10,000, the resin viscosity is high, and the improvement of the flow property is not sufficiently obtained, which degrades the appearance of the resulting intermediate coated film too much. The resin (d2) may be comprised of one type, or of two or more types in order to accomplish a balance between coating properties.

The resin (d2) may be polyester resin having similar composition as the resin (b2) as long as it satisfies the relationship represented by formulae (5) and (6).

It is possible to improve the heat flow property of the resin layer of the intermediate coated film by using the resin (d2) in the step (II) of baking. Therefore, the smoothness of the surface of the coated film can be largely improved, even if it is contact with the electrodeposition coated film underlying thereof to form integral structure. In order to reduce the melt viscosity on heat flowing, it is important for the polyester resin (d2) to have relatively low molecular weight as compared with the acrylic resin (d1). It is preferable to improve the smoothness of the surface of the coated film and the interlaminar bonding strength of the coated films by addition modification using Carjurer E-10 (monoepoxide having a branched alkyl group with 10 carbon atoms, commercially available from Shell Chemical Co.) and the like to increase secondary hydroxyl groups in the resin.

In order to accomplish the technical effect, it is desired for a weight ratio (d1/d2) of the resin (d1) to the resin (d2) to be within the range of 5/5 to 9/1. When the weight ratio is larger than 9/1, the amount of the resin (d2) is small, and the heat flow property is not sufficiently obtained. Therefore, the smoothness of the surface of the coated film is not sufficiently obtained. In addition, the technical effect of improving the interlaminar bonding strength to the electrodeposition coated film or top coated film is not also sufficiently obtained. On the other hand, when the amount of the resin (d2) is too large as compared with the resin (d1), the amount of the core component in the resin particles is too large, and it is difficult to prepare the coating by water dispersing.

The curing agent (e) may be of any types as long as it is possible to cure each resin component on heating, but preferred is amino resin suitable as a curing agent for the intermediate coating resin.

In order to form the coated film, it is required for the amino resin to have a solubility parameter (δe) that satisfies a relationship represented by the following formula:

[δe−(δd1+δd2)/2]≦±0.2

and to be compatibilized with a main binder (the resins d1 and d2) comprising the intermediate coating. When the curing agent, which does not satisfy the relationship represented by the formula, is used, the curing agent does not sufficiently remain in the intermediate coated film layer, and it diffuses in the uncured electrodeposition coated film layer on the step of baking. Therefore, the coated film is undercured. Examples of the amino resins include melamines, and preferred is butylated melamine having hydrophobicity.

As the other curing agent (e) usable in the present invention, the blocked isocyanate (c) described in the electrodeposition coating and/or water soluble methylated melamine resin may optionally be used in suitable amounts together with the amino resin.

It is desired for a weight ratio of the curing agent (e) to the total weight of the resin components (d1) and (d2), which varies depending to degree of crosslinking necessary to an application of the cured coated film, to be within the range of 15 to 40% by weight in view of physical properties of the coated film and the adaptability to applying the top coating. When the weight ratio is smaller than 15% by weight, the coated film is undercured, and the physical properties of the coated film, such as mechanical strength, are degraded. In addition, the coating thinner resistance of the coated film is poor on applying the top coating, which degrades the appearance of the coated film. On the other hand, when the weight ratio is larger than 40% by weight, the coated film is overcured, and the physical properties of the coated film, such as impact resistance, are degraded. The curing agent (e) may be used in combination of two or more in order to adjust the physical properties and degree of curing of the coated film.

The resin dispersion for the aqueous intermediate coating is prepared by neutralizing an acidic group in the resin component (d1) with an inorganic base, such as ammonia, sodium hydroxide and potassium hydroxide or an organic base, and by mixing with the resin (d2) and the curing agent (e) to be emulsified and dispersed in water as a anionic resin dispersion. Examples of the organic bases include primary, secondary and tertiary amines containing a linear or branched alkyl group having 1 to 20 carbon atoms, such as methylamine, dimethylamine, trimethylamine, ethylamine, diethylamine, triethylamine, isopropylamine, diisopropylamine and dimethyldodecylamine; primary and secondary amines containing a linear or branched alkyl group having 1 to 20 carbon atoms and a linear or branched hydroxyalkyl group having 1 to 20 carbon atoms, such as monoethanolamine, diethanolamine, monomethyldiethanolamine, dimethylmoneethanolamine and 2-amino-2-methylpropanol; tertiary amines containing a linear or branched hydroxyalkyl group having 1 to 20 carbon atoms, such as triethanolamine, tripropanolamine and tridodecylalcoholamine; substituted or non-substituted linear polyamines having 1 to 20 carbon atoms, such as diethylenetriamine and triethylenetetramine; substituted or non-substituted cyclic monoamines having 1 to 20 carbon atoms, such as morpholine, N-methyl morpholine and N-ethyl morpholine; substituted or non-substituted cyclic polyamines having 1 to 20 carbon atoms, such as piperazine, N-methyl piperazine and N,N-dimethyl piperazine; and the like.

The aqueous intermediate coating is at least comprised of particles D comprising the resin (d1), the resin (d2) and the curing agent (e), and the pigment dispersion. The resin (d1) is comprised in the particles D as a shell, and the resin (d2) and the curing agent (e) are comprised in the particles D as a core.

The particles D have an average diameter of 0.01 to 0.5 μm, preferably 0.02 to 0.3 μm, more preferably 0.05 to 0.2 μm. When the average diameter is smaller than 0.0 μm, the amount of the neutralizing agent and emulsifying agent necessary to water dispersing the resin component is too large, which degrades the water resistance. On the other hand, when the average diameter is larger than 0.5 μm, the dispersibility of the particles is degraded, and the storage stability of the intermediate coating is degraded.

Since the aqueous intermediate coating is applied on the uncured electrodeposition coated film after applying the electrodeposition coating, defects such as the mixing or inversion of the layers, and sag occur. In the present invention, in order to prevent the defects, the aqueous intermediate coating may optionally comprise a viscosity adjusting agent well known in the art.

In the present invention, acrylic resin particles prepared by emulsion polymerization can be suitably used as a viscosity adjusting agent.

The acrylic resin particles are synthesized by basically using acrylic monomer and/or non-acrylic monomer with water soluble polymerization initiator under the presence of a suitable emulsifying agent in water medium according to emulsion polymerization process well known in the art.

The acrylic monomer and/or non-acrylic monomer used in the present invention are the same as described in the resin (b1).

In order to crosslink the inner portion of the particles, a suitable amount of multifunctional monomer may be used as the other monomer used in the present invention. Examples thereof include divinylbenzene, ethylene glycol di(meth)acrylate, neopentyl glycol di(meth)acrylate, 1,6-hexanediol di(meth)acrylate, trimethylolpropane tri(meth)acrylate and the like.

When the copolymerization with at least one of the multifunctional monomers is conducted, the particles is so-called “microgel”, which is insoluble in organic solvent. The microgel, which is well known as a viscosity adjusting agent, is useful in the present invention.

As the emulsifying agent, a reactive emulsifying agent is preferable in order to improve the water resistance of the synthesized resin. The reactive emulsifying agent as used herein refers to the emulsifying agent having a reactive double bond in the molecular thereof (a sort of macromonomer). Examples thereof include monomers having sulfonic acid or sulfonate, such as “Antox MS-60” and “Antox MS-2N” commercially available from Nippon Nyukazai Co., Ltd., “Aquaron HS” commercially available from Dai-ichi Kogyo Seiyaku Co., Ltd., “Adeka Reasoap SE (NE)” commercially available from Asahi Denka Co., Ltd. and “Eleminol JS-2” commercially available from Kao Corporation.

It is preferable to conduct the emulsion polymerization by using directly the resin (d1) comprising the aqueous intermediate coating or a polymer emulsifying agent formed by solubilizing or dispersing in an aqueous medium using a suitable amount of neutralizing agent in order to secure the dispersibility of the acrylic resin particles in the coated film and the water resistance of the coated film.

Water swelling type resin particles obtained by copolymerizing at least one of the monomers having the acidic group and neutralizing with a suitable base after the copolymerization can be used in the present invention as a useful viscosity adjusting agent for an aqueous coating. It is desired for the resin particles to be resin designed such that the core portion has hydrophobic plastic structure and the shell portion has hydrophilic structure containing an acidic group. The core portion of the particles may have crosslinked structure in order to secure the granularity after water swelling.

It is desired for the acrylic resin particles to be molecular designed to have a hydroxyl number of 10 to 150. When the hydroxyl number is smaller than 10, the curability of the resulting coated film is degraded. On the other hand, when the hydroxyl number is higher than 150, excess hydroxyl groups remain in the coated film after curing, which degrades its water resistance. With regard to the hydroxyl groups in the acrylic resin-particles, the smoothness of the surface of the coated film can be improved by using a primary hydroxyl group together with a secondary hydroxyl group to control the velocity of curing reaction.

It is desired for the acrylic resin particles to have a number average molecular weight of 50,000 to 300,000, preferably 100,000 to 200,000.

The number average molecular weight of the resin particles can be adjusted by using a suitable amount of chain transfer agent well known in the art on emulsion polymerization. Examples of the chain transfer agents include mercaptans (thiols), such as n-dodecyl mercaptan and t-dodecyl mercaptan, or styrene dimer and the like.

When the number average molecular weight is smaller than 50,000, the technical effects of controlling the viscosity are not sufficiently obtained. On the other hand, when the number average molecular weight is higher than 300,000, the viscosity of the resin solution is too high, and it has great effect on the flow property on curing under applied heat, which degrades the appearance of the resulting intermediate coated film too much.

The microgel, of which the inner portion has crosslinked structure, is insoluble in a medium of gel permeation chromatography (GPC) well known as a method for measuring a molecular weight of polymer substances, such as tetrahydrofuran. Therefore, the average molecular weight thereof can not be measured, and the specified range of the average molecular weight is not applied.

When the particles are of the water swelling type in order to improve the technical effects of control the viscosity by the acrylic resin particles, it is desired for the resin particles to be molecular designed to have a acid value of 5 to 8, preferably 10 to 60. When the acid value is smaller than 5, the technical effects of water swelling by neutralizing the acid group are not obtained. On the other hand, when the acid value is higher than 80, excess acid groups remain in the coated film after curing, which degrades its water resistance.

It is desired for the acrylic resin particles to have an average particle diameter of 0.01 to 0.5 μm, preferably 0.02 to 0.3 μm, more preferably 0.05 to 0.2 μm, as described in the particles D. When the average particle diameter is smaller than 0.01 μm, the amount of the neutralizing agent and emulsifying agent necessary to water dispersing the resin component is too large, which degrades the water resistance of the coated film. On the other hand, when the average diameter is larger than 0.5 μm, the dispersibility of the particles is degraded, and the storage stability of the intermediate coating is degraded.

Examples of the viscosity adjusting agent other than the acrylic resin particles include cellulose-based viscosity adjusting agent, such as viscose, methylcellulose, ethylcellulose, hydroxyethylcellulose and the like (for example, “Zirrhose MH” and “Zirrhose H” commercially available from Hoechst AG); alkali thickening type viscosity adjusting agent, such as sodium polyacrylate, polyvinyl alcohol, carboxymethylcellulose and the like (for example, “Primal ASE-60”, “Primal TT-615” and “Primal RM-5” commercially available from Rohm and Haas Co., “Ucar Polyphobe” commercially available from Union Carbide Corporation) and the like; nonionic viscosity adjusting agent, such as polyvinyl alcohol, polyethylene oxide and the like (for example, “Adekanol UH-420”, “Adekanol UH-462” and “Adekanol UH-472” commercially available from Asahi Denka Co., Ltd., “Primal RH-1020” commercially available from Rohm and Haas Co., “Kuraray Poval” commercially available from Kuraray Co., Ltd. and the like); urethane association type viscosity adjusting agent containing urethane bond in amphiphatic molecule, such as “Adekanol SDX-1014” commercially available from Asahi Denka Co., Ltd.; and the like.

Among the viscosity adjusting agents, the urethane association type viscosity adjusting agent containing urethane bond in molecule, by which the technical effects of controlling the viscosity is sufficiently obtained, can be suitably used in the present invention.

The viscosity adjusting agent including also the acrylic resin particles may be used alone, or in combination of two or more.

It is desired for the amount of the viscosity adjusting agent to be within the range of 0.01 to 4-0 parts by weight, preferably 0.05 to 30 parts by weight, more preferably 0.1 to 20 parts by weight, based on the solid content of the aqueous intermediate coating. When the amount of the viscosity adjusting agent is smaller than 0.01 parts by weight, the technical effects of controlling the viscosity are not sufficiently obtained. On the other hand, when the amount of the viscosity adjusting agent is larger than 30 parts by weight, the flow property is degraded too much, which degrades the appearance of the baked coated film.

The aqueous intermediate coating may comprise elastomer. It is possible to impart flexibility to the resulting intermediate coated film and to improve the impact resistance and chipping resistance by comprising elastomer. In the present invention, since the resin layer (β) in direct contact with the intermediate coated film is formed in the plural layered electrodeposition coated film, the unite between the physical properties of the electrodeposition coated film and intermediate coated film is improved, and the impact resistance and chipping resistance are improved too much.

It is desired for the elastomer to be designed to have a transition temperature of −110 to 10° C. When the transition temperature is higher than 10° C., the technical effects of improving the flexibility and impact resistance of the resulting coated film are not sufficiently obtained. On the other hand, it is actually difficult to design the elastomer having a glass transition temperature of lower than −110° C. The designed glass transition temperature may be determined by calculating an expected value from a known value of the glass transition temperature and a formulation ratio based on raw materials for preparing the elastomer (monomer or homopolymer).

It is desired for the elastomer to have a number average molecular weight of 1,000 to 300,000, preferably 5,000 to 200,000. When the number average molecular weight is smaller than 1,000, the impact resistance (chipping resistance) is not sufficiently obtained. On the other hand, when the number average molecular weight is higher than 300,000, the viscosity of the resin is too high, and it is difficult to handle in operation, such as emulsification and dispersion of the resulting resin.

Examples of the elastomers include homopolymer of conjugated diene-based monomer, such as butadiene, isoprene and chioroprene, or random or block copolymer of conjugated diene-based monomer and monomer, such as ethylene, propylene, ethylidene, norbornene, dicyclopentadiene, 1,4-hexadiene, vinyl acetate, styrene, acrylonitrile, isobutylene and (meth)acrylic acid (ester); urethane-based thermoplastic elastomer synthesized by a polyaddition reaction of diisocyanate and diol; polyester-based thermoplastic elastomer synthesized by ester exchange reaction and polycondensation reaction using raw materials, such as dimethyl terephthalate, 1,4-butanediol, polypropylene glycol and poly(tetramethylene) glycol; polyamide-based thermoplastic elastomer synthesized by ester exchange reaction and polycondensation reaction using raw materials, such as, lactam, dicarboxylic acid and polyether diol.

It is possible to be stably present in the aqueous intermediate coating by using water dispersed or water soluble elastomer as the elastomer.

In the method for water dispersing the elastomer, the elastomer may be introduced in an aqueous medium, such as an emulsion by separately applying a dispersant, such as a dispersing resin and surface active agent. It is preferable for the elastomer dispersing resin to be formed by dispersing the elastomer directly in the resin (d1) comprising the aqueous intermediate coating or dispersing in an aqueous medium together with the elastomer using a suitable amount of neutralizing agent in order to secure the dispersibility of the elastomer particles in the coated film and the water resistance of the coated film. In another method, the technical effects are accomplished by using directly telechelic oligomer, to which a polar functional group, such as acidic group and nonionic group is introduced, or by dispersing in an aqueous medium after anion-modifying using a suitable amount of basic neutralizing agent to form a self-emulsified emulsion.

Emulsion of conjugated diene-based rubber, such as polybutadiene and polyisoprene, or acrylic rubber emulsion obtained by emulsion polymerization may be used directly in the coating.

It is required for the section of the intermediate coated film to be designed to have microdomain structure such that the elastomer particles are dispersed phase and the resins (d1) and (d2) are continuous phase. It is desired for the elastomer dispersion to have an average diameter of submicron order, particularly 0.01 to 0.2 μm in order to maintain good appearance of the surface of the intermediate coated film. When the average diameter of the elastomer particles is smaller than 0.01 μm, the amount of the neutralizing agent and emulsifying agent necessary to water dispersing the resin component is too large, which degrades the water resistance of the coated film. On the other hand, when the average diameter is larger than 0.2 μm, the appearance of the intermediate coated film is degraded.

It is desired for the amount of the elastomer based on the solid content of the aqueous intermediate coating to be within the range of 5 to 40% by weight, preferably 10 to 20% by weight of solid content. When the amount of the elastomer is smaller than 5% by weight, the technical effect of improving the chipping resistance of the resulting coated film is not sufficiently obtained. On the other hand, when the amount of the elastomer is larger than 40% by weight, the appearance of the intermediate coated film is degraded too much.

The resin solid content refers to the total solid content of the all resin binder comprising the intermediate coated film including the elastomer, the resins (d1) and (d2) as a main resin of the intermediate coating, the curing agent (e) and pigment dispersing agent.

The intermediate coating generally comprises a pigment. Examples of the pigments used in the intermediate coating include the pigment that is the same as described in the electrodeposition coating. It is preferable to mainly use the inorganic coloring pigment in view of the improvement of the weather resistance, the secureness of the opacifying properties and the cheapness. Particularly preferred is titanium dioxide, because it has good opacifying properties of white color and it is cheap.

The pigment may use together with an organic coloring pigment. Examples of the organic coloring pigments include azochelate pigment, insoluble azo pigment, condensated azo pigment, phthalocyanine pigment, indigo pigment, perylene pigment, dioxane pigment, quinacridone pigment, isoindolinone pigment and the like.

It is possible to form a gray colored aqueous intermediate coating by mainly using carbon black and titanium dioxide as the pigment. In addition, it is possible to form a set gray colored aqueous intermediate coating having the same lightness or hue as a top coating, or a color aqueous intermediate coating combined with various coloring pigment, which has been design for luxury cars in recent years. It is desired for a weight ratio (PWC) of the pigment to the total weight of the pigment and resin solid content contained in the intermediate coating to be within the range of 10 to 60% by weight.

When the weight ratio is smaller than 10% by weight, the amount of the pigment is too small, and the opacifying properties are degraded. On the other hand, when the weight ratio is larger than 60% by weight, the amount of the pigment is too large, and the viscosity of the coating on curing increases. Therefore, the flow property is degraded, and the appearance of the coated film is degraded.

The resin solid content as used herein refers to the total solid content of the all resin binder comprising the base coated film including the main resin, the curing agent and pigment dispersing resin.

The pigment is added to the intermediate coating on the step of preparing the coating after preparing a pigment paste by dispersing the pigment in a dispersing resin generally used.

The pigment dispersing resin has a structure comprising pigment miscible portion and hydrophilic portion and resin species thereof are not limited, but can be prepared by a method well known in the art.

It is desired for the pigment dispersing resin to have a number average molecular weight of 1,000 to 100,000, preferably 2,000 to 70,000, more preferably 4,000 to 50,000. When the number average molecular weight is smaller than 1,000, the dispersion stability is not sufficiently obtained. On the other hand, when the number average molecular weight is higher than 100,000, the viscosity of the resin is too high, and it is difficult to handle in operation.

Examples of the commercially available pigment dispersions preferably used include “Disper byk190”, “Disper byk182” and “Disper byk184” commercially available from BYK Chemie Co., “EFKA Polymer 4550” commercially available from EFKA Co., “Solsperse 27000”, “Solsperse 41000” and “Solsperse 53095” commercially available from Avecia Co. and the like.

The pigment dispersion is mixed and dispersed together with the pigment by a well known method to obtain a pigment dispersion paste. The amount of the pigment dispersing resin in the pigment dispersion paste is within the range of 1 to 20% by weight, preferably 1 to 15% by weight, based on the solid content of the paste. When the amount of the pigment dispersing resin is smaller than 1% by weight, it is difficult to secure the dispersion stability of the pigment. On the other hand, when the amount of the dispersing resin is larger than 20% by weight, the physical properties are degraded.

The aqueous intermediate coating is prepared by mixing at least the resin particles D and the pigment dispersion paste as a essential component, optionally the viscosity adjusting agent and/or the elastomer, and the other additives for the coating. Examples of the other additives include ultraviolet absorbing agent, oxidation inhibiting agent, anti-foaming agent, surface control agent, foaming inhibitor, curing accelerator (or accelerator) and the like.

A method of applying the intermediate coating is not limited, but it is conducted by using an air electrostatic spray coater, which is so-called “react gun”; a rotary spray electrostatic coater, which is so-called “micro micro (uu) bell”, “micro (u) bell”, and “meta bell”; and the like. Preferred is the method by the rotary spray electrostatic coater.

It is desired for the intermediate coated film to have a dry thickness, which varies depending on its application, of 5 to 40 μm, preferably 10 to 30 μm. When the dry thickness is smaller than 5 μm, it is difficult to opacify the substrate of the intermediate coated film. In addition, the coated film is broken. On the other hand, when the dry thickness is larger than 40 μm, the distinctiveness is degraded, or defects, such as unevenness and sag cause [0143] It is suitable for the intermediate coated film to have a dry thickness of 30 to 40 μm in order to minimize the effect of the surface roughening of the electrodeposition coated film and obtain the impact resistance (chipping resistance) and weather resistance.

However, in the present invention, since the electrodeposition coated film has a self-stratifying structure and the resin layer (β) in direct contact with the intermediate coated film in the electrodeposition coated film is formed from weather resistance resins (b1) and (b2) having excellent heat flow property, the coated film has surface smoothness and weather resistance as good as a 3 coat film obtained by a conventional coating process even if the intermediate coated film has smaller thickness, which is within the range of 10 to 30 μm, than the conventional intermediate coated film.

It is possible to impart chipping resistance to the electrodeposition coated single film by designing the resin layer (β) of the electrodeposition coated film to have a dynamic glass transition temperature of 40 to 90° C. In addition, it is possible to impart chipping resistance as good as a 3 coat film obtained by a conventional coating process to the electrodeposition coated film, even if the intermediate coated film has relatively small thickness, which is within the range of 10 to 30 μm, by designing the dynamic glass transition temperature of the intermediate coated film Tg(d) to satisfy a relationship represented by the following formula:

[Tg(b)−Tg(d)]≦±20° C.

In the process for forming a multi layered coated film of the present invention, it is possible to decrease the total thickness of whole 3 coat film by not more than 20%, while maintaining basic properties of the coated film, as compared with the conventional process. Therefore, the technical effects of accomplishing resource saving, energy saving and cost saving are sufficiently obtained.

In the step (II), the uncured electrodeposition coated film and uncured intermediate coated film are simultaneously heated and cured. It is desired for the curing temperature to be within the range of 130 to 180° C., preferably 140 to 170° C. in order to obtain a cured coated film having high degree of crosslinking. When the curing temperature is higher than 180° C., the coated film is too hard and brittle. On the other hand, when the curing temperature is lower than 130° C., the coated film is undercured, and the physical properties of the coated film, such as solution resistance and mechanical strength, are degraded.

When the step (I′) is not conducted, the resin components (a), and (b1) and (b2) in the electrodeposition coated coating composition are orientated depending on a solubility parameter of each resin to form a self-stratifying structure. When the baking is completed to cure the coated film, the cured electrodeposition coated film having a self-stratifying structure such that the resin component (a) is present at the side in direct contact with the electrically conductive substrate and the resin components (b1) and (b2) are present at the side in direct contact with the intermediate coated film is obtained by the step of heating for baking. When the resin components (b1) and (b2) are in direct contact with the intermediate coated film to form the resin layer (β) and satisfy the relationships of the solubility parameter and dynamic grass transition temperature with the intermediate coated film, the technical effects of the present invention are sufficiently obtained.

It is required for a ratio (α/β) of a thickness of the resin layer (α) in direct contact with the electrically conductive substrate to a thickness of the resin layer (β) in direct contact with the intermediate coated film to be within the range of 1/5 to 5/1 in the electrodeposition coated film layer of the multi layered coated film after the step (II) whether the step (II) is conducted or not.

When the self-stratifying structure of the electrodeposition coated film layer is not sufficiently obtained after the step (II) and the thickness ratio (α/β) is out of the range, at least one of the physical properties of the coated film, such as corrosion resistance, weather resistance and chipping resistance, and the appearance of the coated film is degraded.

Step (III)

In the process for forming a multi layered coated film of the present invention, it is the step of applying a base top coating on the intermediate coated film to form an uncured base coated film. Aqueous base top coating and process for applying it

The aqueous base top coating, which is applied mainly in order to impart beautiful appearance, such as lustrousness and elegance to the coated film or color thereof and maintain them, includes aqueous color base top coating, aqueous metallic coating and aqueous solid base top coating.

The aqueous base top coating used in the step is not limited as long as it is prepared by dissolving or dispersing binder resin in water optionally comprising a water soluble medium, such as alcohol.

Examples of the coated film forming resins, which are not limited, include acrylic resin, polyester resin, alkyd resin, urethane resin and the like. The coated film forming resins are used in combination with curing agent, such as amino resin and/or blocked isocyanate. Preferred is the combination of acrylic resin and/or polyester resin and melamine resin in view of dispersibility of the pigment and workability.

The aqueous base top coating may be used as a metallic base coating by employing a brilliant pigment, or as a solid base coating by employing a coloring pigment such as red, blue and black, and/or an extender pigment without employing the brilliant pigment.

The brilliant pigment is not limited, but includes, for example colorless or colored metallic brilliant materials such as metal or alloy, and mixture thereof, interference mica powder, colored mica powder, white mica powder, graphite or colorless or colored planular pigment. Preferred are a colorless or colored metallic brilliant material such as metal or alloy and mixture thereof. Examples of the metals include aluminium, aluminium oxide, copper, zinc, iron, nickel, tin and the like.

Shape of the brilliant pigment is not limited, but for example a scale-like pigment having an average diameter (D50) of 2 to 50 μm, and a thickness of 0.1 to 5 μm is preferred.

It is desired for a weight ratio (PWC) of the brilliant pigment to the total weight of the pigment and resin solid content contained in the aqueous base coating to be within the range of 0.01 to 20% by weight. When the PWC is smaller than 0.01% by weight, the opacifying properties of the intermediate coated film underlying thereof are degraded. On the other hand, when the PWC is larger than 20% by weight, the amount of the pigment is too large, and the appearance of the resulting base coated film is degraded.

The resin solid content as used herein refers to the total solid content of the all resin binder comprising the base coated film including the main resin, the curing agent and pigment dispersing agent.

Examples of pigments other than the brilliant pigment basically include a coloring pigment and an extender pigment as described in the electrodeposition coating and intermediate coating. The pigment may be used alone, or in combination of two or more.

The total pigment content (PWC) comprising the brilliant pigment and all the other pigment in the aqueous base coating is within the range of generally 0.1 to 50% by weight, preferably 0.5 to 40% by weight, more preferably 1 to 30% by weight. When the PWC is smaller than 0.1% by weight, the opacifying properties of the intermediate coated film underlying thereof are degraded. On the other hand, when the PWC is larger than 50% by weight, the amount of the pigment is too large, and the appearance of the resulting base coated film is degraded.

The pigment is added to the base coating after preparing a pigment dispersion paste by using a pigment dispersing resin according to a well known process. The pigment dispersing resin may be the same as used for the aqueous intermediate coating.

The other additives used for the aqueous base coating and a process of preparing the aqueous base coating include the same as described in the intermediate coating.

The base coating is prepared by self-emulsifying the component comprising the solvent type thermosetting resin as a binder or dispersing the component in an aqueous medium using a suitable dispersant together with a curing agent after optionally neutralizing the component with a suitable amount of acid or base. The pigment is formulated to the base coating together with the resin particles at the formulation ratio after forming a pigment dispersion paste by using a suitable dispersant.

Well known technique as to the aqueous base coating is disclosed in Japanese Patent Kokai Publication Nos. 145565/1994 and 311396/1996, and is suitable for the present invention. An aqueous metallic coating composition comprising polyether polyol, metallic pigment paste dispersing a brilliant pigment and emulsion resin obtained by emulsion polymerization process as a binder, which is disclosed in Japanese Patent Kokai Publication No. 311043/2001, has excellent lustrousness, and is suitably used for the present invention. Preferred is an aqueous metallic base coating commercially available from Nippon Paint Co., Ltd. under the trade name of “AquaRex AR-2000”.

The aqueous base coating is applied on the cured intermediate coated film formed in the steep (II) to form an uncured base coated film. The applying method to be used includes the method described as the method of applying the aqueous intermediate coating in the step (II). When the base coating is applied on an automobile body, it is conducted by the applying method using the combination of an air electrostatic spray coater and rotary spray type electrostatic coater in order to impart the coated film to high elegance.

After applying the aqueous base coating, the step of preheating an uncured base coated film at the temperature lower than curing temperature, preferably 60 to 120 C for 1 to 15 minutes may be optionally conducted before applying a top coating in the subsequent step (IV) in order to improve the finishing of the coated film.

It is desired for the base coated film to have a dry thickness, which varies depending on its application, of 5 to 30 μm, preferably 10 to 20 μm. When the dry thickness is smaller than 5 μm, color shade causes. On the other hand, when the dry thickness is larger than 30 μm, the distinctiveness is degraded, or defects, such as unevenness and sag cause. In addition, the base coated film is not sufficiently obtained in view of the cost for applying the coating and for economic reasons.

Step IV

In the process for forming a multi layered coated film of the present invention, it is the step of simultaneously heating and curing the uncured base coated film prepared in the step (III) and an uncured clear coated film after applying a clear top coating on the uncured base coated film to form the clear coated film.

Clear Coating and Process for Applying it

The clear coating is applied for protecting the base coated film or for smoothing surface irregularity and irritated appearance of the metallic base coated film due to the brilliant pigment contained therein.

The clear coating is not limited as long as it has been conventionally used for coating on the automobile body, but includes those composed of a coated film forming resin (binder), a curing agent, and the other additives.

The coated film forming resin is not limited, but includes acrylic resin, polyester resin, urethane resin and the like, these are employed in combination with a curing agent such as amino resin and/or blocked isocyanate resin.

Preferred is the combination of acrylic resin and/or polyester resin and amino resin, or acrylic resin and/or polyester resin having epoxy curing system and carboxylic acid from the viewpoint of its transparency, acid rain-etching resistance and the like.

The clear coating is typically prepared by self-emulsifying after neutralizing the component comprising them as a resin binder and curing agent with acid or base or dispersing the component in an aqueous medium using a suitable dispersant. In addition, it may be prepared by desolvating the resin component to powder.

Since the clear coating is applied on the uncured base coated film after applying the aqueous base coating, it is preferable for the clear coating to contain a viscosity adjusting agent well known in the art as an additive in order to prevent solubilization or inversion between the layers, or causing sag. Examples thereof preferably include the viscosity adjusting agent the same as described in the intermediate coating. The amount of the viscosity adjusting agent is within the range of 0.01 to 10 parts by weight, preferably 0.02 to 8 parts by weight, more preferably 0.03 to 6 parts by weight, based on 100 parts by weight of resin solid content of the clear coating. When the amount is smaller than 0.01 parts by weight, the technical effect of controlling the viscosity is not sufficiently obtained. On the other hand, when the amount is larger than 10 parts by weight, the flow property is degraded, and the appearance of the coated film.

As well known technique as to the aqueous clear coating, a high solid clear coating composition having acid rain resistance, scuff resistance and yellowing resistance is disclosed in Japanese Patent Kokai Publication Nos. 128446/1994, 166741/1994, 224146/1995, 259667/1996, 71706/1997 and 104803/1997, and is suitable for the present invention. A powder clear coating composition disclosed in Japanese Patent Kokai Publication No. 139874/2001 is the most superior in reducing coating environmental load, and is suitable for the present invention. As examples of the clear coating, preferred is a high solid clear coating commercially available from Nippon Paint Co., Ltd. under the trade name of “MAC-O-1800W”.

The applying method to be used includes the method described as the method of applying the aqueous intermediate coating in the step (II).

It is desired for the clear coated film to have a dry thickness, which varies depending on its application, of 20 to 70 μm, preferably 30 to 50 μm. When the dry thickness is smaller than 20 μm, the whole appearance of the multi layered coated film is degraded. On the other hand, when the dry thickness is larger than 70 μm, the distinctiveness is degraded, or defects, such as unevenness and sag cause on applying it. In addition, the clear coated film is not sufficiently obtained in view of the cost for applying the coating and for economic reasons.

In the step (IV), the base top coated film and uncured clear coated film are simultaneously heated and cured. It is desired for the curing temperature to be within the range of 110 to 180° C., preferably 120 to 160° C. in order to obtain a cured coated film having high degree of crosslinking. When the curing temperature is higher than 180° C., the coated film is too hard and brittle. On the other hand, when the curing temperature is lower than 110° C., the coated film is undercured, and the physical properties of the coated film, such as acid rain resistance, solution resistance and mechanical strength, are degraded. The curing time, which varies depending on the curing temperature, is suitably within the range of 10 to 60 minutes when the curing temperature is 120 to 160° C.

It is desired for the multi layered coated film obtained by the process for forming a multi layered coated film of the present invention to have a total thickness of 40 to 200 μm, preferably 60 to 150 μm. When the thickness is smaller than 40 μm, the mechanical strength and appearance of the coated film is not sufficiently obtained for coating on the automobile body. On the other hand, when the thickness is larger than 200 μm, the cost for applying the coating is high and low VOC is not sufficiently accomplished.

Since the electrodeposition coating applied in the step (I) has a self-stratifying structure and its function is divided, the electrodeposition coated film having a balance between the coated film performances, such as impact resistance (chipping resistance), surface smoothness and rust prevention accomplished at high level can be obtained. In addition, the electrodeposition coated film has excellent weather resistance (peel resistance on weathering) even if it has single layered structure.

Therefore, a multi layered coated film prepared by optionally preheating the uncured electrodeposition coated film (obtained in the step I) in the step (I′);

applying an aqueous intermediate coating by wet on wet coating, and simultaneously baking it together with the uncured electrodeposition coated film in the step (II); and

applying a base top coating and clear coating by wet on wet coating, and simultaneously baking them in the steps (III) to (IV), has excellent impact resistance (chipping resistance), excellent corrosion resistance, excellent weather resistance and good appearance (without yellowing) of the coated film as good as coated film obtained by a conventional 3 coat 3 bake coating process. In addition, it is possible to decrease the total thickness of whole 3 coat film by not more than 20%, while maintaining basic properties of the coated film, as compared with the conventional process. Therefore, the technical effects of accomplishing resource saving and cost saving are sufficiently obtained.

The step of baking the electrodeposition coating can be omitted from a conventional 3 coat 3 bake coating process by using the 2 wet on coating process of the present invention. Therefore, new coating system for solving the problems of process simplifying, cost saving, energy consumption saving and environmental load reducing can be provided.

### EXAMPLES

The present invention will be further explained in detail in accordance with the following examples, however, the present invention is not limited to these examples. In the examples, “part” and “%” are based on weight unless otherwise specified.

### Preparation of Electrodeposition C

### Production Example 1

### Production of Blocked Isocyanate Curing Agent (c-1)

A reaction vessel equipped with a stirrer, a nitrogen-gas inlet, a condenser and a thermometer was charged with 222 parts of isophorone diisocyanate and diluted with 56 parts of methyl isobutyl ketone. Then, 0.2 parts of dibutyltin dilaurate was added thereto and heated to 50° C., to which 17 parts of methyl ethyl ketoxime was added while keeping a temperature of the content not more than 70° C. It was then kept at 70° C. for one hour until an absorption of isocyanate moiety in infrared absorption spectrum substantially all disappeared. It was diluted with 43 parts of n-butanol to obtain a blocked isocyanate curing agent solution (c-1) having a solubility parameter c-1 of 11.8 and a solid content of 70% by weight.

### Production Example 2

### Production of Blocked Isocyanate Curing Agent (c-2)

A reaction vessel equipped with a stirrer, a nitrogen-gas inlet, a condenser and a thermometer was charged with 199 parts of hexamethylene diisocyanate trimer and diluted with 39 parts of methyl isobutyl ketone. Then, 0.2 parts of dibutyltin dilaurate was added thereto and heated to 50° C., to which 44 parts of methyl ethyl ketoxime and 87 parts of ethyleneglycol mono-2-ethylhexyl ether were added while keeping a temperature of the content not more than 70° C. It was then kept at 70° C. for one hour until an absorption of isocyanate moiety in infrared absorption spectrum substantially all disappeared. It was diluted with 43 parts of n-butanol to obtain a blocked isocyanate curing agent solution (c-2) having a solubility parameter δc-2 of 10.7 and a solid content of 80% by weight.

### Production Example 3

### Production of Anionic Polyester Resin (b-2)

A reaction vessel equipped with a stirrer, a decanter, a nitrogen-gas inlet, a thermometer and a dropping funnel was charged with 20.5 parts of neopentyl glycol, 90.4 parts of trimethylolpropane, 295.7 parts of phthalic anhydride, 142.0 parts of isophthalic acid, 24.2 parts of 2,2′-dimethylolbutanoic acid and 0.6 parts of dibutyltin oxide as reaction catalyst and 60 parts of xylene as reflux solvent, and kept at 150° C. in nitrogen blanket. Then, 538.7 parts of Carjurer E 10 (monoepoxide having branch alkyl (C-10) group, available from Shell Chemical Co.) was added dropwise over 30 minutes from the dropping funnel and heated to 210 to 230° C. to conduct condensation reaction for about 5 hours. It was then diluted with 230 parts of methyl isobutyl ketone to obtain an anionic polyester resin (b2) having acid value of 5, hydroxyl value of 72, number average molecular weight of 1,500, solubility parameter δb2 of 10.3 and solid content of 80%.

### Production Example 4

### Production of Cation-Modified Epoxy Resin a and Aqueous Emulsion Particles (A-1)

A reaction vessel equipped with a stirrer, a decanter, a nitrogen-gas inlet, a thermometer and a dropping funnel was charged with 2,400 parts of bisphenol A type epoxy resin having epoxy equivalent of 188 (available from Dow Chemical Co. as DER-331J), 141 parts of methanol, 168 parts of methyl isobutyl ketone and 0.5 parts of dibutyltin dilaurate, and mixed uniformly at 40° C. to dissolve. Then, 320 parts of 2,4-/2,6-tolylene diisocyanate (mixing weight ratio of 80/20) was added dropwise over 30 minutes to exothermically heat to 70° C. To the content, 5 parts of N,N-dimethylbenzylamine was added and heated to a temperature of 120° C. at which reaction continued for 3 hours with removing methanol until epoxy equivalent reacted to 500. Then, 644 parts of methyl isobutyl ketone, 341 parts of bisphenol A and 413 parts of 2-ethylhexanoic acid were added thereto and kept at 120° C. to complete reaction until epoxy equivalent reacted to 1,070, followed by cooling the content to 110° C. At 110° C., a mixture of 241 parts of diethylenetriamine diketimine (methyl isobutyl ketone solution having a solid content of 73 weight %) and 192 parts of N-methylethanolamine was added and reacted for one hour to obtain a cation-modified epoxy resin (resin a) having number average molecular weight of 2,100, amine value of 74, hydroxyl value of 160, resin softening point of 130° C. according to JIS-K-5665, solubility parameter δa of 11.4 and solid content of 74 weight %. It was subjected to determination of infrared spectrum to confirm that the resin had oxazolidone ring by an absorption at 1,750 cm-1.

Into the cation-modified epoxy resin solution, 1,240 parts of blocked isocyanate curing agent solution c-1 and 90 parts of acetic acid were added, and then diluted with ion-exchanged water to non-volatile content of 32 wt %, followed by condensing it at a reduced pressure to non-volatile content of 36 wt % to obtain aqueous emulsion particles A-1 containing cation-modified epoxy resin and particle size of 0.16 μm determined by laser light scattering method.

### Production Example 5

### Production of Aqueous Emulsion Particles (A-2)

Into 3,472 parts of the cation-modified epoxy resin solution obtained in Production Example 4, 1,240 parts of blocked isocyanate curing agent solution c-1 obtained in Production Example 1, 1,085 parts of the anionic polyester resin solution obtained in Production Example 3 and 90 parts of acetic acid were added, and then diluted with ion-exchanged water to non-volatile content of 32 wt %, followed by condensing it at a reduced pressure to non-volatile content of 36 wt % to obtain aqueous emulsion particles A-2 containing cation-modified epoxy resin and particle size of 0.18 μm determined by laser light scattering method.

### Production Example 6

### Production of Cation-Modified Epoxy Resin b1-1 and Aqueous Emulsion Particles (B-1)

A reaction vessel equipped with a stirrer, a condenser, a nitrogen-gas inlet, a thermometer and a dropping funnel was charged with 50 parts of methyl isobutyl ketone and heated to keep at 110° C. under nitrogen blanket. It was then charged dropwise over 3 hours by the dropping funnel with a mixture of 18.6 parts of 2-hydroxypropyl acrylate, 22.1 parts of 2-ethylhexyl methacrylate, 30 parts of N,N-dimethylaminoethyl methacrylate, 9.5 parts of n-butyl acrylate, 4.8 parts of methyl methacrylate, 15 parts of styrene and 4 parts of t-butyl peroctoate, to which 0.5 parts of t-butyl peroctoate was added dropwise and kept at 110° C. for 1.5 hours to obtain a cation-modified epoxy resin (resin b1) having solid content of 65 wt %, number average molecular weight of 7,500, hydroxyl value of 80, amine value of 107 and solubility parameter δb1-1 of 10.3.

Into the cation-modified epoxy resin solution, 43 parts of the blocked isocyanate curing agent solution c-2 obtained in Production Example 2 and 3 parts of acetic acid were added and mixed for 30 minutes. It was then diluted with ion-exchanged water to non-volatile content of 32 wt %, and condensed at a reduced pressure to non-volatile content of 36 wt % to obtain aqueous emulsion particles B-1 containing cation-modified epoxy resin and particle size of 0.14 μm determined by laser light scattering method.

### Production Example 7

### Production of Aqueous Emulsion Particles (B-2)

Into 108 parts of the cation-modified epoxy resin solution obtained in Production Example 6, 54 parts of the blocked isocyanate curing agent solution c-2 obtained in Production Example 2, 38 parts of the anionic polyester resin solution obtained in Production Example 3 and 3 parts of acetic acid were added and mixed for 30 minutes. It was then diluted with ion-exchanged water to non-volatile content of 32 wt %, and condensed at a reduced pressure to non-volatile content of 36 wt % to obtain aqueous emulsion particles B-2 containing cation-modified epoxy resin and particle size of 0.16 μm determined by laser light scattering method.

### Comparative Production Example 1

### Production of Cation-Modified Epoxy Resin b1-2 and Aqueous Emulsion Particles (B-3)

A reaction vessel equipped with a stirrer, a condenser, a nitrogen-gas inlet, a thermometer and a dropping funnel was charged with 50 parts of methyl isobutyl ketone and heated to keep at 110° C. under nitrogen blanket. It was then charged dropwise over 3 hours by the dropping funnel with a mixture of 20.6 parts of 2-hydroxypropyl methacrylate, 43.3 parts of 2-ethylhexyl methacrylate, 30 parts of N,N-dimethylaminoethyl methacrylate, 0.5 parts of n-butyl methacrylate, 5.6 parts of styrene and 4 parts of t-butyl peroctoate, to which 0.5 parts of t-butyl peroctoate was added dropwise and kept at 110° C. for 1.5 hours to obtain a cation-modified epoxy resin (resin b1-2) having solid content of 65 wt %, number average molecular weight of 7,500, hydroxyl value of 80, amine value of 107 and solubility parameter δb1-2 of 10.7.

Into the cation-modified epoxy resin solution, 43 parts of the blocked isocyanate curing agent solution c-2 obtained in Production Example 2 and 3 parts of acetic acid were added and mixed for 30 minutes. It was then diluted with ion-exchanged water to non-volatile content of 32 wt %, and condensed at a reduced pressure to non-volatile content of 36 wt % to obtain aqueous emulsion particles B-2 containing cation-modified epoxy resin and particle size of 0.13 μm determined by laser light scattering method.

### Production Example 8

### Production of Aqueous Emulsion Particles (C-1)

Into 135 parts of the cation-modified epoxy resin solution obtained in Production Example 4, 38 parts of the anionic polyester resin (b2) obtained in Production Example 3, 108 parts of the cation-modified acrylic resin (b1-1) obtained in Production Example 6, 36 parts of the blocked isocyanate coring agent (c-1) obtained in Production Example 1, 54 parts of the blocked isocyanate curing agent solution (c-2) obtained in Production Example 2, and 5 parts of acetic acid were added and mixed for 30 minutes. It was then diluted with ion-exchanged water to non-volatile content of 32 wt %, and condensed at a reduced pressure to non-volatile content of 36 wt % to obtain aqueous emulsion particles C-1 containing cation-modified epoxy resin and particle size of 0.18 μm determined by laser light scattering method.

### Production Example 9

### Production of Pigment Dispersing Resin for Electrodeposition Coating

A reaction vessel equipped with a stirrer, a condenser, a nitrogen-gas inlet and a thermometer was charged with 710 parts of bisphenol A type epoxy resin having an epoxy equivalent of 198 (available from Shell Chemical Co. as Epon 829) and 289.6 parts of bisphenol A, and reacted at a temperature of 150 to 160° C. for one hour in nitrogen blanket. After cooling to 120° C., 406.4 parts of a methyl isobutyl ketone solution of tolylene diisocyanate half-blocked with 1-ethylhexanol (solid content of 95 wt %) was added to react. The reaction mixture was kept for one hour at 110 to 120° C., to which 1,584.1 parts of ethyleneglycol n-monobutyl ether was added, followed by cooling to 85 to 95° C. to mix uniformly to obtain a reacted material.

Separately, another reaction vessel was charged with 384 parts of a methyl isobutyl ketone solution of 2-ethylhexanol half-blocked tolylene diisocyanate (solid content of 95 wt %) and 104.6 parts of dimethylethanolamine, and mixed for one hour at 80° C. It was then charged with 141.1 parts of a 75% lactic acid solution and 47.0 parts of ethyleneglycol n-butyl ether, and mixed for 30 minutes to obtain a quaternerizing agent having a solid content of 85 wt %.

Thereafter, 620.46 parts of the quaternerizing agent was added to the above obtained reacted material and kept at a temperature of 85 to 95° C. to reach to acid value of 1, thus obtaining a resin solution of pigment dispersing resin having a number average molecular weight of 2,200 and a solid content of 56 wt %.

### Production Example 10

### Production of Pigment Dispersing Paste for Electrodeposition Coating

The following ingredients were dispersed in a sand mill to obtain a pigment paste (F-1) having a solid content of 51 wt % and a particle size of 5 μm or less.

TABLE 1

| Ingredients | Parts by weight |
|---|---|
| Pigment dispersing resin varnish | 50.0 |
| of Production Example 9 | |
| Titanium dioxide | 87.0 |
| Carbon black | 0.5 |
| Aluminum phosphomolybdate | 1.5 |
| Clay | 11.0 |
| Ion-exchanged water | 101.0 |

### Production Example 11 to 14

### Production of Electrodeposition Coating

Electrodeposition coatings were prepared using the particles A obtained in Production Examples 4 to 5, particles B obtained in Production Examples 6 to 7, particles C obtained in Production Example 8 and pigment dispersing paste obtained in Production Example 10 in the weight ratios and combinations as shown in Table 2. It was noted that each paint had a pigment content in paint (PWC) of 18 wt %, and a solid content of 20 wt % and that a curing accelerator was prepared as a dispersing paste of dibutyltin oxide and formulated in an amount of 1.5% by weight based on tin metal content in a solid content of paint. Diluent of the paints was ion-exchanged water.

The following Table 2 shows combinations of ingredients and formulating weight ratios. The particles A, B and C were all formulated in the form of emulsion.

TABLE 2

| Electrodeposition | | | | | Comparative |
|---|---|---|---|---|---|
| coating | Production Example | | | | Production |
| Ingredients | 11 | 12 | 13 | 14 | Example 3 |
| Particles A | A-1 | A-2 | A-2 | — | A-1 |
| Emulation | (136) | (163) | (168) | | (168) |
| Particles B | B-2 | B-1 | B-2 | — | B-3 |
| Emulsion | (142) | (115) | (110) | | (110) |
| Particles C | — | — | — | C-1 | — |
| Emulsion | | | | (278) | |
| Pigment | F-1 | F-1 | F-1 | F-1 | F-1 |
| dispersing paste | (59) | (59) | (59) | (59) | (59) |

(Numbers in brackets show parts.)

As is noted from the above Table 2, each ingredient of Production Examples 11 to 14 satisfies the previously-mentioned layer separation conditions: resin a/(resin b1+resin b2)=1/1 (weight ratio).

### Comparative Production Example 2

### Production of Prior Art Electrodeposition Coating

An electrodeposition coating was prepared from the particles A-1 obtained in Production Example 4 and the pigment paste obtained in Production Example 10. It was noted that each paint had a pigment content in paint (PWC) of 18 wt %, and a solid content of 20 wt % and that a curing accelerator was prepared as a dispersing paste of dibutyltin oxide and formulated in an amount of 1.5% by weight based on tin metal content in a solid content of paint. Diluent of the paints was ion-exchanged water.

### Comparative Production Example 3

### Production of an Electrodeposition Coating That Does not Satisfy the Layer Separation Condition

An electrodeposition coating was prepared from the particles A-1 obtained in Production Example 4, the particles B-3 obtained in Comparative Production Example 1 and the pigment paste obtained in Production Example 10. It was noted that each paint had a pigment content in paint (PWC) of 18 wt %, and a solid content of 20 wt % and that a curing accelerator was prepared as a dispersing paste of dibutyltin oxide and formulated in an amount of 1.5% by weight based on tin metal content in a solid content of paint. Diluent of the paints was ion-exchanged water.

The combinations of ingredients and formulating weight ratios are indicated in Table 2. The particles A, B and C were all formulated in the form of emulsion.

Production of Aqueous Intermediate Coating Paint

### Production Example 15

### Production of Anionic Polyester Resin (d2-1)

A reaction vessel equipped with a stirrer, a decanter, a nitrogen-gas inlet, a thermometer and a dropping funnel was charged with 21.6 parts of neopentyl glycol, 95.2 of trimethylolpropane, 344.9 parts of phthalic anhydride, 165.7 parts of isophthalic acid, 26.2 parts of 2,2′-dimethylol butanoic acid and 0.6 parts of dibutyltin oxide as reaction catalyst and 60 parts of xylene as reflux solvent, and kept at 150° C. in nitrogen blanket. Then, 628.4 parts of Carjurer E 10 (monoepoxide having branch alkyl (C-10) group, available from Shell Chemical Co.) was added dropwise over 30 minutes from the dropping funnel and heated to 210 to 230° C. to conduct condensation reaction for about 5 hours. It was then diluted with 230 parts of methyl isobutyl ketone to obtain an anionic polyester resin (d2-1) having acid value of 6, hydroxyl value of 72, number average molecular weight of 1,800, solubility parameter δd2-1 of 9.9 and solid content of 80%.

### Production Example 16

### Production of Anion-Modified Acrylic Resin d1-1 and Aqueous Emulsion Particles (D-1)

A reaction vessel equipped with a stirrer, a condenser, a nitrogen-gas inlet, a thermometer and a dropping funnel was charged with 25.0 parts of dipropyleneglycol methyl ether and 18.0 parts of propyleneglycol methyl ether, and heated to keep at 110° C. under nitrogen blanket. It was then charged dropwise over 3 hours by the dropping funnel with a mixture of 15.4 parts of 2-hydroxypropyl methacrylate, 69.0 parts of 2-ethylhexyl methacrylate, 6.1 parts of methacrylic acid, 9.4 parts of n-butyl acrylate and 1.2 parts of t-butyl peroctoate, to which 0.3 parts of t-butyl peroctoate was added dropwise and kept at 110° C. for 1.5 hours to obtain an anion-modified acrylic resin (resin d1-1) having solid content of 70 wt %, number average molecular weight of 20,000, hydroxyl value of 60, acid value of 40 and solubility parameter δd1-1 of 9.9.

Into the anion-modified acrylic resin solution, 72 parts of butylated melamine curing agent having a solid content of 60 wt % and a solubility parameter δe-1 of 9.9 (available from Mitsui Chemical Co. as Yuban 20N-60), 43 parts of the anionic polyester resin solution obtained in Production Example 15 and 3 parts of dimethylethanolamine were added and mixed for 30 minutes. It was then diluted with ion-exchanged water to non-volatile content of 50 wt % to obtain aqueous dispersion particles D-1 containing cation-modified acrylic resin and particle size of 0.15 μm determined by laser light scattering method.

### Production Example 17

### Production of Anionic Polyester Resin (d2-2)

A reaction vessel equipped with a stirrer, a decanter, a nitrogen-gas inlet, a thermometer and a dropping funnel was charged with 152 parts of neopentyl glycol, 180 of trimethylolpropane, 218 parts of hexahydrophthalic anhydride, 165 parts of isophthalic acid, 26.2 parts of 2,2′-dimethylol butanoic acid, 61 parts of neopentylglycol hydroxypailec acid ester, 154 parts of ε-caprolactone, 0.6 parts of dibutyltin oxide as reaction catalyst and 30 parts of xylene as reflux solvent, and kept at 150° C. in nitrogen blanket. Then, 79 parts of Carjurer E 10 (monoepoxide having branch alkyl (C-10) group, available from Shell Chemical Co.) was added dropwise over 30 minutes from the dropping funnel and heated to 210 to 230° C. to conduct condensation reaction for about 5 hours. It was then diluted with 200 parts of methyl isobutyl ketone to obtain an anionic polyester resin (d2-2) having acid value of 8, hydroxyl value of 210, number average molecular weight of 800, solubility parameter δd2-2 of 11.0 and solid content of 80%.

### Production Example 18

### Production of Anion-Modified Acrylic Resin d1-2 and Aqueous Dispersion Particles (D-2)

A reaction vessel equipped with a stirrer, a condenser, a nitrogen-gas inlet, a thermometer and a dropping funnel was charged with 25.0 parts of dipropyleneglycol methyl ether and 18.0 parts of propyleneglycol methyl ether, and heated to keep at 110° C. under nitrogen blanket. It was then charged dropwise over 3 hours by the dropping funnel with a mixture of 16.2 parts of 2-hydroxypropyl acrylate, 14.0 parts of isobutyl acrylate, 9.1 parts of methacrylic acid, 40.7 parts of n-butyl acrylate, 20 parts of styrene and 1.2 parts of t-butyl peroctoate, to which 0.3 parts of t-butyl peroctoate was added dropwise and kept at 110° C. for 1.5 hours to obtain an anion-modified acrylic resin (resin d1-2) having solid content of 70 wt %, number average molecular weight of 20,000, hydroxyl value of 70, acid value of 59 and solubility parameter δd1-2 of 11.0.

Into the anion-modified acrylic resin solution, 72 parts of butylated melamine curing agent having a solid content of 60 wt % and a solubility parameter δe-1 of 11.0 (available from Mitsui Chemical Co. as Yuban 122), 43 parts of the anionic polyester resin solution obtained in Production Example 17 and 3 parts of dimethylethanolamine were added and mixed for 30 minutes. It was then diluted with ion-exchanged water to non-volatile content of 50 wt % to obtain aqueous dispersion particles D-2 containing cation-modified acrylic resin and particle size of 0.12 μm determined by laser light scattering method.

### Production Example 19

### Production of Pigment Dispersing Paste for Intermediate Coating Paint

The following ingredients were mixed and then dispersed in a paint conditioner containing glass beads to obtain a pigment paste (F-2) having a particle size of 5 μm or less.

TABLE 3

| Ingredients | Parts by weight |
|---|---|
| Pigment dispersing agent | 9.4 |
| available from | |
| BYK Chemie Co. | |
| as “Disper byk 190” | |
| Ion-exchanged water | 36.8 |
| Titanium dioxide | 34.5 |
| Barium sulfate | 34.4 |
| Talc | 6.0 |

### Production Example 20

### Production of Acrylic Resin Particles—Viscosity Controller (G-1)

A reaction vessel was charged with 40.7 parts of ion-exchanged water and heated to 80° C. with mixing under nitrogen blanket. Separately, a mixture of 31.7 parts of n-butyl acrylate, 31.7 parts of n-butyl methacrylate, 13.9 parts of 2-hydroxypropyl acrylate, 47.1 parts of 2-ethylhexyl methacrylate and 4.6 parts of methacrylic acid were emulsified with 15 parts of the anion-modified acrylic resin solution obtained in Production Example 15, one part of dimethyl-ethanolamine and 50 parts of ion-exchanged water to form an emulsion. To the reaction vessel, the emulsion and an initiator of 0.3 parts of ammonium persulfate and 15.0 parts of deionized water were added dropwise over two hours with stirring. After finishing the addition, it was aged for 2 hours with keeping its temperature and then cooled to 40° C., followed by filtering with a 400 mesh filter. Then, 4 parts of dimethylethanolamine was added thereto to obtain an acrylic resin particles (G-1) having an average particle size of 0.2 μm determined by laser light scattering method, a number average molecular weight of 200,000, a solid content of 50 wt %, an acid value of 30 and a hydroxyl value of 60.

### Production Examples 21 to 25

### Production of Aqueous Intermediate Coating Paint

Aqueous intermediate coating paints were prepared using the particles D obtained in Production Examples 16 and 18, the pigment dispersing paste obtained in Production Example 19, the acrylic resin particles obtained in Production Example 20 and other agents such as viscosity controller and elastomer particles commercially available in the weight ratios and combinations as shown in Table 4. It was noted that each paint had a pigment content in paint (PWC) of 30 wt %. Diluent of the intermediate coating paints was thinner, i.e. ion-exchanged water which was formulated to a desired paint viscosity.

The following Table 4 shows combinations of ingredients and formulating weight ratios. The particles D, viscosity controller and elastomer resin particles are all formulated based on the weight of aqueous dispersion.

TABLE 4

| Intermediate | | | | | |
|---|---|---|---|---|---|
| Coating | Production Example | | | | |
| Ingredients | 21 | 22 | 23 | 24 | 25 |
| Particles D | D-1 | D-1 | D-1 | D-1 | D-2 |
| | (200) | (180) | (170) | (150) | (150) |
| Acrylic resin | — | G-1 | G-1 | G-1 | G-1 |
| particles | | (120) | (120) | (120) | (20) |
| Other viscosity | — | — | SDX | SDX | SDX |
| controller | | | (17) | (17) | (17) |
| Elastomer | | | | H-1 | H-1 |
| particles | | | | (19) | (19) |
| Pigment | F-2 | F-2 | F-2 | F-2 | F-2 |
| dispersing paste | (71) | (71) | (71) | (71) | (71) |

(Numbers in brackets show parts.)

SDX in Table 4 shows Adekanol SDX-1014 (urethane viscosity controller containing 30 wt % effective component; available from Asahi Denka Co., Ltd.).

H-1 in Table 4 shows Laxster-3622A (elastomer emulsion, acrylonitrile-butadiene resin, having a number average molecular weight of about 200,000 an average particle size of 0.1 μm, a solid content of 52.5 wt % and a designed glass transition temperature of −30° C.; available from Dainippon Ink & Chemicals Inc.)

### Comparative Production Example 4

### Production of Prior Art Type Aqueous Intermediate Coating Paint

A reaction vessel was charged with 72.9 parts of neopentyl glycol, 40.3 parts of trimethylolpropane, 59.2 parts of phthalic anhydride and 73.1 parts of adipic acid and was reacted at a temperature of 200 to 230° C. for 5 hours. Then, 5.8 parts of trimellitic anhydride was added thereto to react one hour at 180° C., followed by adding butyl cellosolve to obtain a water dispersible polyester resin having an acid value of 40, a number average molecular weight of about 6,000 and a resin solid content of 70 wt %. To 117 parts of the water dispersible polyester, 34 parts of a curing agent, Cymel 370 (water soluble melamine resin available from Mitsui Cytech Co., Ltd.) was added and was sufficiently mixed to form polyester solution. The solution was added by 5.9 parts of 2-amino-2-methylpropanol as neutralizing agent and mixed for 20 minutes to neutralize carboxyl groups in the polyester resin molecules, which was then diluted with ion-exchanged water to non-volatile content of 50 wt %, thus obtaining an aqueous dispersion mainly containing water dispersible polyester resin (average particle size of 0.12 μm determined by laser light scattering method).

The pigment dispersing paste obtained in Production Example 19 was added thereto to form an intermediate coating paint having pigment content (PWC) of 30%.

### Examples 1 to 10

Electrodeposition coating was conducted using the electrodeposition coatings obtained in Production Examples 11 to 14 on dull steel panels treated with zinc phosphate, at 200 volts to form coatings with a dry thickness of 20 μm. If necessary, some of the panels were subjected to pre-heating process at 100° C. for 5 minutes. Tables 5 to 6 indicate whether the pre-heating was conducted or not.

The panels that were either pre-heated or not were air-spray coated wet-on-wet with the aqueous intermediate coating paints obtained in Production Examples 21 to 25, and heated at 60° C. for 3 minutes, followed by curing at 160° C. for 15 minutes to form intermediate coatings having a dry thickness of 10 μm. The resulting composite films were subjected to evaluation on SDT, surface roughness (Ra value), dynamic Tg of each layer and yellowing of intermediate layer, and the results of the evaluation are shown in Tables 5 to 6.

Then, the coated panels were over-coated using base paint and clear paint to obtain dry thickness of 13 μm for the base paint and 35 μm for the clear paint. Coating was conducted by air spray coating with wet-on-wet and then the two coated layers were cured at a temperature of 140° C. for 30 minutes. The base paint was aqueous silver metallic base paint, available from Nippon Paint Co., Ltd. as AquaRex AR 2000, and the clear paint was solvent-type high solid clear paint, available from Nippon Paint Co., Ltd. as MAC-O-1800 W.

Air spray coating for the intermediate coating paint and the over coating paints was conducted as following coating viscosity and diluting thinner.

(Aqueous intermediate coating paint)

Thinner: Ion-exchanged water

Viscosity: 40 seconds/No.4 Ford cup/20° C.

(Aqueous base paint)

Thinner: Ion-exchanged water

Viscosity: 45 seconds/No.4 Ford cup/20° C.

(Clear paint)

Thinner: EEP (ethoxyethylpropionate)/S-150 (aromatic hydrocarbon solvent available from Exxon Co.)

Viscosity: 30 seconds/No.4 Ford cup/20° C.

The composite film obtained by overcoating was subjected to evaluation on total thickness, appearance (wave scan value: W2/W4), weathering peeling test (SUV) and chipping resistance, and the results are shown in Tables 5 and 6.

### Comparative Examples 1 to 4

Comparative Examples 1 and 2 were those obtained by 3-coat-3-bake system, using the prior art type electrodeposition coating.

Electrodeposition coating was conducted using the prior art type electrodeposition coating obtained in Comparative Production Example 2 and cured at 160° C. for 15 minutes to form a dry film having a thickness of 20 μm. It was then coated with the intermediate coating paint and cured at 140° C. for 30 minutes. It was further overcoated with overcoat base and clear paint and then cured at 140° C. for 30 minutes. The intermediate coating paint was one obtained in Production Example 21 and was formed into a dry film having 101 μm for Comparative Example 1 and 30 μm for Comparative Example 2. The overcoating was conducted as same as Examples.

Comparative Example 3 was an example of 2 wet-on-wet method for electrodeposition coating and intermediate coating, using the prior art type electrodeposition coating. Comparative Example 4 was an example of 2 wet-on-wet method for electrodeposition coating and intermediate coating, using the electrodeposition coating in which each resin has solubility parameter not to create layer separation.

Electrodeposition coating was conducted using the electrodeposition coatings obtained in Comparative Production Examples 2 and 3. It was then coated with the intermediate coating paint wet-on-wet and cured. It was further overcoated with overcoat base and clear paint and then cured. The intermediate coating paint was one obtained in Production Example 21 and was formed into a dry film having 10 μm for Comparative Examples 3 and 4. The resulting composite film was subjected to evaluation as same as Examples, and the results are shown in Table 7.

### Comparative Example 5

Comparative Example 5 is an example using prior art type intermediate coating paint having poor storage stability.

Electrodeposition coating was conducted using the electrodeposition coatings obtained in Comparative Production Example 11 and pre-heated. It was then coated with the intermediate coating paint obtained in Comparative Production Example 4 wet-on-wet and cured to form a dry thickness of 10 μm. It was further overcoated with overcoat base and clear paint and then cured. The resulting composite film was subjected to evaluation as same as Examples, and the results are shown in Table 7.

Evaluation method of paint and coated layer

Average particle size

Average particle size was determined by dynamic light scattering method, using an apparatus, Microtac UPA-150 (available from Nikkiso Co., Ltd.)

Condition of Layer Separation of Electrocoated Film

After forming a coated film of electrodeposition coating and intermediate coating, a cross-sectional area of the coated film was observed by Video Microscope (VH-Z 450 available from Keyence Co.). If a layer separation was observed in the electrodeposition coated film, a thickness ratio of α layer/β layer was automatically determined.

Dynamic Glass Transition Temperature

A tin plate was coated either with electrodeposition coating or with both electrodeposition coating and intermediate coating and then cured. The coated film was removed off by mercury and cut to prepare samples for determination. The samples were put in a freezer and cooled to 0° C., and then vibrated at a frequency of 10 Hz and raising rate of temperature of 2° C. per one minute to determine viscoelasticity. A ratio (tan δ) of storage elasticity (E′)/loss elasticity (E″) was calculated and its inflexion point was determined to obtain a dynamic Tg. A dynamic Tg (d) of intermediate coating layer was determined by comparing electrodeposition coating single layer with two layer structure of electrodeposition coating and intermediate coating.

Surface Roughness of a Composite Film of Electrodeposition Coating and Intermediate Coating

Surface roughness (Ra) of the coated film of electrodeposition coating and intermediate coating was determined with a cut-off 2.5 mm by using Handy Surf 30 A (available from Tokyo Seimitsu Co., Ltd.), according to JIS B 0601.

SDT

The coated film of electrodeposition coating and intermediate coating was cut by a knife to reach the substrate and then immersed in salted water (5% salt water) at 55° C. for 240 hours. An adhesive tape was put on a surface of the coated film and peeled off. Evaluation is shown as a maximum width (mm) of peeled area from the cut portions.

SST

The coated film of electrodeposition coating and intermediate coating was cut by a knife to reach the substrate and then sprayed by salted water (5% salt water) at 35° C. for 240 hours. A maximum value of corrosion area generated from the cut portion is shown in mm.

Yellowing Ability of Intermediate Coating

Film yellowing ability for storage stability of the aqueous intermediate paint obtained in Comparative Production Example 4 was determined. The same ability of the aqueous intermediate paint of Production Example 21 to 25 was also determined. The results are shown in Tables 5, 6 and 7.

Determination: Each aqueous intermediate paint of Examples and Comparative Examples was stored at 40° C. for one month and spray-coated, followed by curing at 160° C. for 15 minutes. The resulting coated layer was subjected to yellowing determination by eye sight.

G: Good means no yellowing.

P: Poor means some yellowing.

Determination of Thickness of Coating

A thickness of the composite film including the overcoating was determined by measuring a cut area of coating using Video Microscope (μm).

Evaluation of Appearance of the Composite Film

Total appearance of the composite film after overcoating was determined using “Wave scan-T” available from BYK-Gardner Co., to obtain a measuring value (W2) of a middle wave length range of 800 to 2,400 nm and a measuring value (W4) of a longer wave length range of 50 to 320 nm. The appearance was determined by the W2 and W4 values. The smaller the values, the better the appearance.

Evaluation of Weather Peeling Test

The weather resistance of the composite film after overcoating was evaluated by SUV tester “SUV-W131” available from Iwasaki Denki Co., Ltd. After 10 cycles time, the coated film was cross-cut and an adhesive tape was adhered and peeled off. Evaluation is as G: good means no peeling and P: poor means some peeling.

Evaluation of Chipping Resistance of the Composite Film

The chipping resistance of the composite film after overcoating was determined by cooling the coated panel to −30° C. and equipping it to a sample holder of a stone insufflation tester available from Suga Test Machine Co., Ltd. at an intrusion angle of stones of 90°. Then, 100 g of 7 grade crushed stones were collided to the sample panel at an air pressure of 3 Kg/cm2. The abrasion damages (number, size, place) were evaluated as 5 degrees as follow:

Level 1: Some severe abrasion damages are present on all area of the plate and peeling is reached to a substrate surface.

Level 2: Some abrasion damages are present on all area of the plate and peeling is reached to a substrate surface.

Level 3: Some abrasion damages are present on a portion of the plate and peeling is not reached to a substrate surface.

Level 4: Some small abrasion damages are present on a portion of the plate and peeling is not reached to a substrate surface.

Level 5: Few abrasion damages are present on the plate.

TABLE 5

| | | Example | | | | |
|---|---|---|---|---|---|---|
| Coating process | | 1 | 2 | 3 | 4 | 5 |
| Electro- | Electro- | Production | Production | Production | Production | Production |
| deposition | deposition | Example | Example | Example | Example | Example |
| coating | coating to | 11 | 11 | 11 | 11 | 11 |
| process | be employed | | | | | |
| Presence of preheating | | No | No | Presence | No | Presence |
| process | | | | | | |
| Intermediate | Intermediate | Production | Production | Production | Production | Production |
| coating | coating | Example | Example | Example | Example | Example |
| process | to be | 19 | 20 | 21 | 21 | 22 |
| | employed | | | | | |
| Stratification of | | Presence | Presence | Presence | Presence | Presence |
| electrodeposition | | of | of | of | of | of |
| coated layer (α/β | | stratification | stratification | stratification | stratification | stratification |
| thickness ratio) | | (1/1) | (1/1) | (1/1) | (2/1) | (1/1) |
| Electrodeposition | | | | | | |
| coated film layer | | | | | | |
| Tg (a) | | 130 | 130 | 130 | 130 | 130 |
| Tg (b) | | 60 | 60 | 60 | 60 | 60 |
| Evaluation | SDT peeling | 0.1 | 0.1 | 0.1 | 0.1 | 0.1 |
| of | width | | | | | |
| electro- | SST | 1.0 | 1.0 | 1.0 | 1.0 | 0.9 |
| deposition | corrosion | | | | | |
| | width | | | | | |
| coating | Surface | 0.06 | 0.05 | 0.06 | 0.05 | 0.04 |
| and | roughness | | | | | |
| inter- | Ra | | | | | |
| mediate | Tg (d) | 70 | 70 | 70 | 70 | 65 |
| coating | Yellowing | G | G | G | G | G |
| Evaluation | Total | 78 | 78 | 78 | 78 | 78 |
| of | thickness | | | | | |
| composite | (μm) | | | | | |
| film | Appearance | 13/7 | 14/9 | 13/8 | 16/12 | 13/7 |
| after | (W2/W4) | | | | | |
| overcoating | Weather | G | G | G | G | G |
| | resistance | | | | | |
| | (SUV) | | | | | |
| | Chipping | 3 | 3 | 3 | 3 | 4 |
| | resistance | | | | | |

TABLE 6

| | | Example | | | | |
|---|---|---|---|---|---|---|
| Coating process | | 6 | 7 | 8 | 9 | 10 |
| Electro- | Electro- | Production | Production | Production | Production | Production |
| deposition | deposition | Example | Example | Example | Example | Example |
| coating | coating to | 11 | 12 | 13 | 14 | 11 |
| process | be employed | | | | | |
| Presence of preheating | | No | Presence | Presence | Presence | Presence |
| process | | | | | | |
| Inter- | Inter- | Production | Production | Production | Production | Production |
| mediate | mediate | Example | Example | Example | Example | Example |
| coating | coating to | 22 | 22 | 22 | 22 | 25 |
| process | be employed | | | | | |
| Stratification of | | Presence | Presence | Presence | Presence | Presence |
| electrodeposition | | of | of | of | of | of |
| coated layer (α/β | | stratification | stratification | stratification | stratification | stratification |
| thickness ratio) | | (3/1) | (1/1) | (1/1) | (1/1) | (1/1) |
| Electrodeposition | | | | | | |
| coated film layer | | | | | | |
| Tg (a) | | 120 | 130 | 130 | 125 | 130 |
| Tg (b) | | 55 | 60 | 60 | 55 | 60 |
| Evaluation | SDT peeling | 0.1 | 0.1 | 0.1 | 0.1 | 0.1 |
| of | width | | | | | |
| electro- | SST | 1.1 | 1.0 | 1.0 | 0.9 | 1.0 |
| deposition | corrosion | | | | | |
| coating | width | | | | | |
| and | Surface | 0.06 | 0.07 | 0.05 | 0.08 | 0.05 |
| intermediate | roughness | | | | | |
| coating | Ra | | | | | |
| | Tg (d) | 65 | 65 | 65 | 65 | 70 |
| | Yellowing | G | G | G | G | G |
| Evaluation | Total | 78 | 78 | 78 | 78 | 78 |
| of | thickness | | | | | |
| composite | (μm) | | | | | |
| film | Appearance | 15/12 | 13/8 | 14/9 | 14/8 | 12/6 |
| after | (W2/W4) | | | | | |
| overcoating | Weather | G | G | G | G | G |
| | resistance | | | | | |
| | (SUV) | | | | | |
| | Chipping | 4 | 4 | 4 | 4 | 4 |
| | resistance | | | | | |

TABLE 7

| | | Comparative Example | | | | |
|---|---|---|---|---|---|---|
| Coating process | | 1 | 2 | 3 | 4 | 5 |
| Electro- | Electro- | Compara- | Compara- | Compara- | Compara- | Production |
| depostion | deposition | tive | tive | tive | tive | Example |
| coating | coating to | Production | Production | Production | Production | 11 |
| process | be employed | Example | Example | Example | Example | |
| | | 2 | 2 | 2 | 3 | |
| Presence of preheating | | No | No | No | No | No |
| process | | | | | | |
| Intermediate | Intermediate | Production | Production | Production | Production | Comparative |
| coating | coating | Example | Example | Example | Example | Production |
| process | to be | 19 | 19 | 19 | 19 | Example |
| | employed | | | | | 4 |
| Stratification of | | No | No | No | No | No |
| electrodeposition | | stratification | stratification | stratification | stratification | stratification |
| coated layer (α/β | | | | | | |
| thickness ratio) | | | | | | |
| Electrodeposition | | | | | | |
| layer | Tg (t) | 130 | 130 | 130 | 90 | 80 |
| | Tg (a) | — | — | — | — | — |
| | Tg (b) | — | — | — | — | — |
| Evaluation | SDT peeling | 0.1 | 0.1 | 0.1 | 3.5 | 5.0 |
| of | width | | | | | |
| electro- | SST | 1.0 | 1.0 | 1.0 | 4.0 | 6.5 |
| deposition | corrosion | | | | | |
| coating | width | | | | | |
| and | Surface | 0.18 | 0.06 | 0.24 | 0.20 | 0.22 |
| inter- | roughness | | | | | |
| mediate | Ra | | | | | |
| coating | Tg (d) | 70 | 70 | 70 | 70 | 20 |
| | Yellowing | G | G | G | G | P |
| Evaluation | Total | 78 | 98 | 78 | 78 | 78 |
| of | thickness | | | | | |
| composite | (μm) | | | | | |
| film | Appearance | 22/25 | 13/7 | 28/35 | 25/30 | 28/34 |
| after | (W2/W4) | | | | | |
| overcoating | Weather | P | G | P | P | P |
| | resistance | | | | | |
| | (SUV) | | | | | |
| | Chipping | 2 | 3 | 2 | 2 | 1 |
| | resistance | | | | | |

(Note) In case where the electrodeposition Coating is

either one of prior art type or one that does not meet the requirement of stratification condition, so that no stratification happens, the electrodeposition coated film layer only has one Tg which indicates as Tg(t).

Explanation of the Above Results

In view of the comparison in appearance and thickness of the composite film between Example 1, Comparative Examples 1 and 2, the composite film layer obtained in Example 1 reduces 20% in thickness for showing similar appearance to the prior art type three-coat-three-bake system.

In view of the comparison between Example 1 and Comparative Example 3, the composite film layer has superior appearance and physical properties to two wet-on-wet coating method using the prior art type electrodeposition coating.

In view of the comparison between Examples and Comparative Example 5, the intermediate coating paint has better storage stability than the prior art type paint and shows excellent film properties in yellowing resistance, Tg, weather resistance and chipping resistance.

What is claimed is:

1. A process for forming a multi layered coated film comprising the steps of:
(I) conducting electrodeposition coating on an electrically conductive substrate to form an uncured electrodeposition coated film,
(II) applying an intermediate coating on the electrodeposition coated film to form an intermediate coated film, and then simultaneously heating and curing the uncured electrodeposition coated film and the uncured intermediate coated film,
(III) applying a base top coating on the intermediate coated film to form an uncured base coated film
(IV) applying a clear top coating on the base coated film to form a clear coated film, and then simultaneously heating and curing the uncured base coated film and the uncured clear coated film; wherein
the electrodeposition coating forms a self-stratifying coated film at cured condition after finishing the step (II), and
a resin layer (α) in direct contact with the electrically conductive substrate has a dynamic glass transition temperature Tg(a) of 100 to 150° C. and a resin layer (β) in direct contact with the intermediate coated film has a dynamic glass transition temperature Tg(b) of 40 to 90° C. in the electrodeposition coated film formed from the electrodeposition coating.

2. The process for forming a multi layered coated film according to claim 1, wherein the electrodeposition coating comprises a resin (a) having a solubility parameter δa, a resin (b1) having a solubility parameter δb1, a resin (b2) having a solubility parameter δb2, a curing agent (c) and a pigment,
the solubility parameters of the resin components satisfy a relationship represented by the following formulae:
[δa−(δb1+δb2)/2]≧2
(δb1−δb2)≦±0.2
and
the resin layer (α) in direct contact with the electrically conductive substrate is formed from the resin (a), the resin layer (β) in direct contact with the intermediate coated film is formed from the resin (b1) and the resin (b2).

3. The process for forming a multi layered coated film according to claims 1 and 2, wherein the intermediate coating is an aqueous coating, and a dynamic glass transition temperature Tg(d) of the intermediate coated film and a dynamic glass transition temperature Tg(b) of the resin layer (β) in direct contact with the intermediate coated film in the electrodeposition coated film satisfy a relationship represented by the following formula:
[Tg(b)−Tg(d)]≦±20° C.

4. The process for forming a multi layered coated film according to claim 2, wherein the resin (a) is a cation-modified epoxy resin having an amine value of 40 to 150.

5. The process for forming a multi layered coated film according to claim 2, wherein the resin (b1) is a cation-modified acrylic resin having an amine value of 50 to 150, and the resin (b2) is an anionic polyester resin having an acid value of less than 10.

6. The process for forming a multi layered coated film according to claim 2, wherein the curing agent (c) is consisted of a blocked isocyanate, and a solubility parameter (δc) of at least one of the blocked isocyanates, the solubility parameter (δa) of the resin (a), the solubility parameter (δb1) of the resin (b1) and the solubility parameter (δb2) of the resin (b2) satisfy a relationship represented by the following formula:
δa<δc<(δb1+δb2)/2

7. The process for forming a multi layered coated film according to claim 2, wherein the electrodeposition coating consists of particles A comprising at least the resin (a) and the curing agent (c), particles B comprising at least the resin (b1) and the curing agent (c) and a dispersion of the pigment, and the resin (b2) is contained in the particles A and/or the particles B as a core together with the curing agent (c).

8. The process for forming a multi layered coated film according to claim 2, wherein the electrodeposition coating consists of particles C comprising at least the resin (a), the resin (b1) and the curing agent (c), and a dispersion of the pigment, and the resin (b2) and the curing agent (c) are contained in the particles C as a core.

9. The process for forming a multi layered coated film according to claim 2, wherein the electrodeposition coating consists of particles A comprising at least the resin (a) and the curing agent (c); particles B comprising at least the resin (b1) and the curing agent (c); particles C comprising at least the resin (a), the resin (b1) and the curing agent (c); and a dispersion of the pigment; and
the resin (b2) is contained in the particles A and/or the particles B as a core together with the curing agent (c), and the resin (b2) and the curing agent (c) are contained in the particles C as a core.

10. The process for forming a multi layered coated film according to claim 1, wherein the aqueous intermediate coating consists of particles D comprising a resin (d1), a resin (d2) and a curing agent (e), and a dispersion of the pigment, and
the resin (d2) and the curing agent (e) are contained in the particles D as a core.

11. The process for forming a multi layered coated film according to claim 9, wherein the aqueous intermediate coating further comprises a viscosity adjusting agent.

12. The process for forming a multi layered coated film according to claim 9, wherein the aqueous intermediate coating further comprises elastomer.

13. The process for forming a multi layered coated film according to claim 10, wherein the resin (d1) is an anion-modified acrylic resin having an acid value of 10 to 100 and the resin (d2) is polyester resin having an acid value of less than 10, and the aqueous intermediate coating comprises a core/shell type aqueous dispersion prepared from the polyester resin as a core and the acrylic resin as a shell.

14. The process for forming a multi layered coated film according to claim 10, wherein the curing agent (e) is amino resin, and
a solubility parameter (δe) of the curing agent, a solubility parameter (δd1) of the resin (d1) and a solubility parameter (δd2) of the resin (d2) satisfy a relationship represented by the following formula:
[δe−(δd1+δd2)/2]≦±0.2

15. The process for forming a multi layered coated film according to claim 1, wherein
the aqueous intermediate coating comprises a resin (d1) having a solubility parameter (δd1) and a resin (d2) having a solubility parameter (δd2),
the electrodeposition coating comprises a resin (a) having a solubility parameter δa, a resin (b1) having a solubility parameter δb1, a resin (b2) having a solubility parameter δb2, a curing agent (c) and a pigment,
the solubility parameter (δd1) of the resin (d1), the solubility parameter (δd2) of the resin (d2), the solubility parameter (δb1) of the resin (b1) and the solubility parameter (δb2) of the resin (b2) satisfy a relationship represented by the following formulae:
[(δb1+δb2)/2−(δd1+δd2)/2]≧±0.3
(δd1+δd2)≦±0.2

16. The process for forming a multi layered coated film according to claim 1, wherein the base top coating is an aqueous coating.

17. The process for forming a multi layered coated film according to claim 1 comprising the steps of:
(I) conducting electrodeposition coating on an electrically conductive substrate to form an uncured electrodeposition coated film,
(I′) preheating the electrodeposition coated film at the temperature lower than a baking temperature necessary for curing the electrodeposition coated film to form an uncured self-stratifying electrodeposition coated film,
(II) applying an intermediate coating on the electrodeposition coated film to form an intermediate coated film, and then simultaneously heating and curing the uncured electrodeposition coated film and the uncured intermediate coated film,
(III) applying a base top coating on the intermediate coated film to form an uncured base coated film, and
(IV) applying a clear top coating on the base coated film to form the clear coated film, and then simultaneously heating and curing the uncured base coated film and the uncured clear coated film.

18. A multi layered coated film obtained by the process of claim 1 or 17.

19. A electrodeposition coated film part in a multi layered coated film obtained by the process of claim 1 or 17, wherein a ratio (α/β) of a thickness of the resin layer (α) in direct contact with the electrically conductive substrate to a thickness of the resin layer (β) in direct contact with the intermediate coated film is within the range of 1/5 to 5/1 in the electrodeposition coated film formed from the electrodeposition coating.
